(19) United States
(12) Patent Application Publication
(10) Pub. No.: US 2016/0086430 A1
(43) Pub. Date: Mar. 24, 2016

(54) GAMING SYSTEM

(71) Applicants: UNIVERSAL ENTERTAINMENT CORPORATION, TOKYO (JP); ARUZE GAMING AMERICA, INC., Las Vegas, NV (US)

(72) Inventors: Kenta KITAMURA, Tokyo (JP); Susumu MIO, Tokyo (JP); Yuji MIYAGAWA, Tokyo (JP)

(21) Appl. No.: 14/861,533

(22) Filed: Sep. 22, 2015

(30) Foreign Application Priority Data
Sep. 24, 2014 (JP) 2014194349

(51) Int. Cl. G07F 17/32

(52) U.S. Cl. CPC G07F 17/3213

(57) ABSTRACT

Gaming machines execute processes of: determining the symbols to be rearranged by symbol random determination in which random determination probabilities of the symbols are different between the gaming machines; based on the symbols rearranged by the symbol random determination, awarding the special payout; and awarding the special payout by second random determination in which random determination is executed at a predetermined probability, which is different from the symbol random determination.

### CROSS-REFERENCE TO RELATED APPLICATION

This application claims priority from Japanese Patent Application No. 2014-194349, filed on Sep. 24, 2014, which application is incorporated herein by reference in its entirety.

### FIELD OF THE INVENTION

The present invention relates to a gaming system including a gaming machine which variably displays symbols and then rearranges the symbols.

### BACKGROUND OF THE INVENTION

A known gaming system is disclosed in Patent Literature 1 (U.S. Pat. No. 8,758,114), for example. In such a gaming system, plural gaming machines are connected with one another to be able to perform data communications. For example, in each gaming machine capable of performing data communications, random determination is performed to determine whether to award a progressive bonus.

### BRIEF SUMMARY OF THE INVENTION

In the known arrangement, when the random determination of whether to award the progressive bonus is done based on a result of rearrangement of a symbol reel group in each of the gaming machines used in a base game, it is necessary to use either gaming machines which are exactly identical with one another or clone gaming machines which are different from one another in the design of symbols displayed in the symbol reel group but are identical with one another in characteristics, to arrange all gaming machines capable of communicating with one another to have the same probability of winning the progressive bonus.

An object of the present invention is to provide a gaming system in which, even if the probability of awarding a payout is different between gaming machines, probabilities of winning a payout are less different between the gaming machines.

The present invention relates to a gaming system comprising a server which includes: a connection unit connected with gaming machines; and a storage unit configured to store a special payout which is a common payout obtainable by the gaming machines, each of the gaming machines including: a symbol display device configured to display a game result by variably displaying symbols and then rearranging the symbols; and a control unit which is programmed to execute the processes of: (A) determining the symbols to be rearranged on the symbol display device by symbol random determination in which random determination probabilities of the symbols are different between the gaming machines; (B) based on the symbols rearranged by the symbol random determination, awarding the special payout; and (C) awarding the special payout by second random determination in which random determination is executed at a predetermined probability, which is different from the symbol random determination in the process (A).

According to the arrangement above, even if the probability of awarding the special payout is different between the gaming machines on account of the difference in the random determination probability of the symbol random determination, the difference in the winning probability of the special payout is reduced by the second random determination, or the difference is eliminated.

In addition to the above, in the present invention, each of the gaming machines includes an input device configured to receive a bet operation to output a bet amount for executing a game, the server includes a calculation unit configured to receive the bet amount from the gaming machines and calculate the special payout based on the bet amount, and the gaming system further includes a display device configured to display the special payout calculated by the calculation unit.

According to the arrangement above, because the calculation and the display of the special payout are performed on the server side, the processing load on each gaming machine is reduced.

In addition to the above, the control unit is programmed to further execute the process of rearranging the symbols on the symbol display device in a display state corresponding to the special payout determined in the process (C).

According to this arrangement, because both the result of the second random determination and the result of the symbol random determination are displayed on the symbol display device in the form of the rearrangement of the symbols, the number of components is reduced as a dedicated display device is unnecessary, and the control becomes easy.

In addition to the above, the connection unit is further connected with a gaming machine which includes another control unit which is configured to determine the special payout by the symbol random determination and award the special payout.

According to this arrangement, because the winning probability in the second random determination is easily adjusted as compared to cases where the winning probability in the symbol random determination is adjusted in the design stage or by providing a winning probability adjustment unit, a gaming machine including another control unit which awards the special payout based on the symbol random determination is easily connectable, and hence a gaming system in which a large number of and various types of gaming machines are connected by the connection unit is easily realized.

The gaming system further includes a storage unit which is configured to collect a part of each bet on the gaming machines connected to the connection unit at an identical rate, and accumulatively store the part as accumulative storage data, the processing unit awarding the special payout based on the accumulative storage data in the storage unit.

When this arrangement is employed in the present invention, it is easy to award, by utilizing the accumulative storage data which is formed by accumulatively collecting a part of the bet at the same rate, the special payout in an impartial manner to the gaming machines from which the part is collected.

The control unit in the gaming system is programmed to further execute the process of (D) in accordance with a result of the symbol random determination, executing a high-probability game in which the special payout is won at a high probability, and then executing the second random determination.

According to this arrangement, the winning probability of the special payout is increased stepwise, and the expecting degree of the special payout is increased stepwise because the special payout is won based on the second random determination after the end of the high-probability game.

By the present invention, even if the probability of awarding a payout is different between gaming machines, probabilities of winning a payout are arranged to be less different between the gaming machines.

### BRIEF DESCRIPTION OF THE DRAWINGS

FIG. 1 illustrates an operation state of a gaming system.

FIG. 2 illustrates a display state of a display unit.

FIG. 3 illustrates operations of a server and a gaming machine.

FIG. 4 shows the relationship between progressive jackpot values and levels.

FIG. 5A is a functional flow of the gaming machine related to the present invention.

FIG. 5B illustrates payouts of progressive hands.

FIG. 5C illustrates winning probabilities regarding the progressive.

FIG. 6A is a functional flow of the gaming machine.

FIG. 6B illustrates payouts of progressive hands.

FIG. 6C illustrates winning probabilities regarding the progressive.

FIG. 7A illustrates the outline of the progressive.

FIG. 7B illustrates the outline of the progressive.

FIG. 7C illustrates the outline of the progressive.

FIG. 8 is a functional flow of the gaming system.

FIG. 9 is a perspective view of a slot machine in the gaming machine.

FIG. 10 is an electrical block diagram of the gaming machine.

FIG. 11 is a block diagram regarding a game program executed by a main CPU of a motherboard.

FIG. 12 illustrates an example of a payline definition table.

FIG. 13 illustrates an example of a symbol determination table used in a normal game mode.

FIG. 14 illustrates an example of a symbol determination table used in a free game mode.

FIG. 15 illustrates an example of a payout table.

FIG. 16 illustrates an example of the payout table.

FIG. 17 illustrates an example of a mystery random determination table.

FIG. 18A illustrates an example of a jackpot symbol rearrangement state table.

FIG. 18B illustrates an example of a jackpot symbol rearrangement state table.

FIG. 18C illustrates an example of a jackpot symbol rearrangement state table.

FIG. 18D illustrates an example of a jackpot symbol rearrangement state table.

FIG. 18E illustrates an example of a jackpot symbol rearrangement state table.

FIG. 19 shows state shifting in the gaming machine.

FIG. 20 is a flowchart of a main control process of the gaming machine.

FIG. 21 is a flowchart of a coin input/start check process of the gaming machine.

FIG. 22 is a flowchart of a symbol random determination process of the gaming machine.

FIG. 23 is a flowchart of an effect content determination execution process of the gaming machine.

FIG. 24 is a flowchart of a symbol display control process of the gaming machine.

FIG. 25 is a flowchart of a payout determination process of the gaming machine.

FIG. 26 is a flowchart of a free game mode process of the gaming machine.

FIG. 27 is a flowchart of a Kind number determination process of the gaming machine.

FIG. 28 is a flowchart of mystery random determination of the gaming machine.

FIG. 29 illustrates an effect process of the mystery random determination.

FIG. 30 illustrates an effect process of the mystery random determination.

FIG. 31 illustrates an effect process of the mystery random determination.

FIG. 32A illustrates an effect process of a mystery winning process.

FIG. 32B illustrates an effect process of the mystery winning process.

FIG. 32C illustrates an effect process of the mystery winning process.

FIG. 32D illustrates an effect process of the mystery winning process.

FIG. 32E illustrates an effect process of the mystery winning process.

FIG. 32F illustrates an effect process of the mystery winning process.

FIG. 32G illustrates an effect process of the mystery winning process.

FIG. 32H illustrates an effect process of the mystery winning process.

FIG. 32I illustrates an effect process of the mystery winning process.

FIG. 32J illustrates an effect process of the mystery winning process.

FIG. 32K illustrates an effect process of the mystery winning process.

### DETAILED DESCRIPTION OF THE PREFERRED EMBODIMENT

### Gaming System: Outline

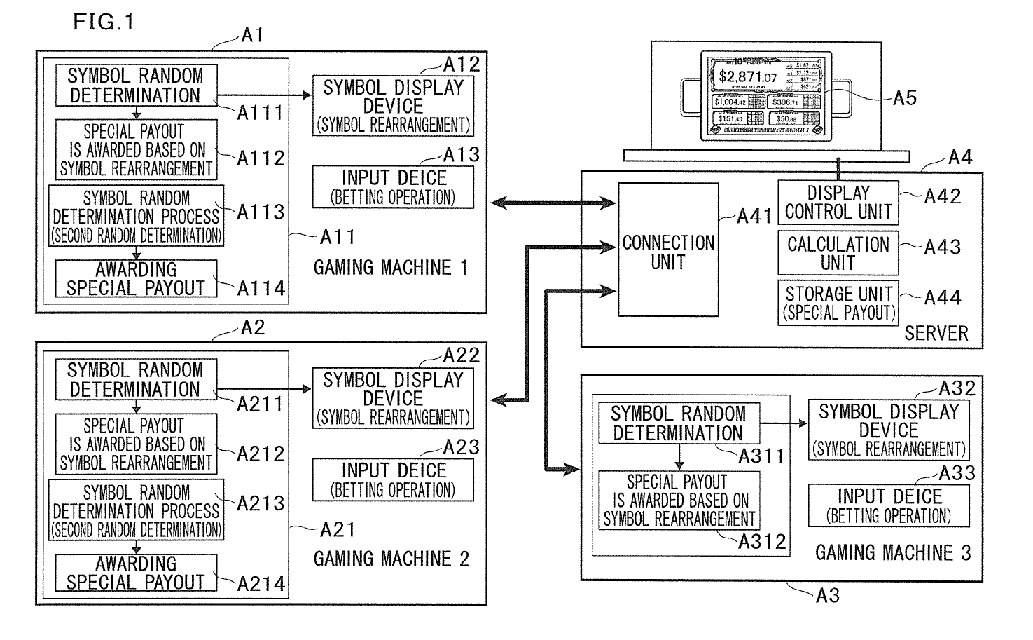

As shown in FIG. 1, a gaming system of the present invention includes plural, e.g., first to third gaming machines A1, A2, and A3, the number of which is three, for example, and a server A4 which is connected with these gaming machines A1, A2, and A3 and performs unitary control of a jackpot amount as a special payout. The server A4 includes a connection unit A41 connected with the gaming machines A1, A2, and A3 and a storage unit A44 storing, as accumulative storage data, a part of a credit bet in each of the first to third gaming machines A1, A2, and A3 at the same rate. The storage unit A44 stores a credit amount which is the resource of linked progressive jackpot which is the special payout and a common payout which can be obtained by the gaming machines A1, A2, and A3. The special payout is not limited to this linked progressive jackpot.

In the gaming system, a part of a bet credit is stored in the storage unit of the server A4 as the accumulative storage data. Alternatively, one of the first to third gaming machines A1, A2, and A3 may function as a host whereas the remaining ones may function as clients, and the accumulative storage data may be stored in the storage unit of one of the gaming machines. However, when the resource of the linked progressive jackpot is managed by the server A4 which is different from the gaming machines as in the present invention, deterioration in the processing ability of the gaming machine functioning as the host is less likely to occur. Such an advantage is particularly important not when a relatively small number of, e.g., three as in the present embodiment, of the gaming machines are connected by the connection unit A41 but when hundreds of gaming machines or all gaming machines provided in all casino halls are connected by the connection unit A41 and the linked progressive jackpot is obtained in a large scale.

The first to third gaming machines A1, A2, and A3 have a function of determining a prize by symbol random determination, but are different from one another in the gaming characteristics of the symbol random determination. In cases where the gaming machines are different in the gaming characteristics, for example, if the linked progressive jackpot as the special payout is triggered by the rearrangement of a predetermined number of (six or more in the present embodiment) symbols (jackpot symbol in the present embodiment) defined in each gaming machine, the winning probability of the special payout resulting from the symbol random determination is different between the gaming machines due to the symbol arrangement on the reels of each gaming machine, or the like. In the present invention, the winning probability of the special payout is arranged to be identical between plural types of gaming machines which are different from one another in the winning probability of the special payout if the winning probability is determined based on the symbol random determination. This uniformization is done by performing random determination which is different from the symbol random determination. That is to say, in a gaming system including gaming machines in which whether to award a prize is determined based on symbol random determination and which are different from one another in the winning probability of special payout, the winning probability of the special payout is uniformized between the gaming machines by performing random determination different from the symbol random determination, at a predetermined random determination timing.

In the present embodiment, the first and second gaming machines A1 and A2 perform symbol random determination, i.e., random determination based on an input to a later-described spin button 602. After the symbols are variably displayed on reels, the symbols are stopped at stop positions on the reels determined by the random determination, and whether linked progressive jackpot is won is determined based on the state of the rearranged symbols on the reels.

Furthermore the gaming machines have a function of performing random determination equivalent to second random determination of the present invention at a predetermined random determination timing, and when winning the linked progressive jackpot as a result of the random determination, moving and stopping the reels on which the symbols are provided, so that the symbols are rearranged in accordance with the linked progressive jackpot. The predetermined random determination timing in the present embodiment is a timing at which a chance game (in which the winning probability of the special payout of the present invention is higher than the winning probability in the base game) which is triggered when a bonus symbol is rearranged in the base game ends. The predetermined random determination timing, however, is not limited to this.

In the first and second gaming machines A1 and A2, the linked progressive jackpot can be won both in the symbol random determination and in the second random determination. However, because the state of the rearranged symbols displayed on the symbol display device (six or more jackpot symbols), which indicates the winning of the linked progressive jackpot, is identical between a case where the linked progressive jackpot is won in the symbol random determination and a case where the linked progressive jackpot is won in the second random determination. On this account, for the player, it is impossible to know whether the linked progressive jackpot having been won is obtained in the symbol random determination or in the second random determination.

In addition to the above, the third gaming machine A3 has a function of determining a prize solely based on the symbol random determination. In this gaming machine A3, when a symbol rearrangement state in which a predetermined number or more jackpot symbols are rearranged is achieved, the linked progressive jackpot is awarded.

The gaming system is designed such that the winning probability of the special payout as a prize in the second random determination is identical between the gaming machines which are different in the characteristics regarding the symbol random determination as described above. Not limited to such adjustment of the probability in the design stage, the gaming machine having the second random determination function may be provided with a probability adjustment unit (not illustrated) which is able adjust the winning probability in the second random determination, and the probability may be suitably adjusted as an operator operates an operating switch connected to the probability adjustment unit.

In the present embodiment, furthermore, an annular reel strip on which plural types of symbols are printed is provided on the outer circumference of each of the reels, and these reel strips are displayed to be viewable in a display window 150 of a later-described symbol display device.

When a predetermined number of (e.g., six) jackpot symbols with which the special payout is awarded are included in the symbols rearranged to be viewable in the display window 150, the special payout is awarded. A prize, however, is awarded by achieving a winning combination other than this. That is to say, a payout is awarded when a winning combination constituted by symbols other than the jackpot symbol is rearranged in the display window 150. When such an embodiment of the present invention is employed, because the first gaming machine A1 and the second gaming machine A2 are different from each other in the arrangement of the jackpot symbols for awarding the special payout and the arrangement of other symbols, the gaming machines are different from each other not only in the probability of occurrence of a winning combination of the jackpot symbols for awarding the special payout but also in the probability of the occurrence of a winning combination which is not for the special payout, from the perspective of the symbol random determination. However, while in the present invention the linked progressive jackpot which is the special payout is arranged to be won at the same probability in the second random determination between the first and second gaming machines (A1 and A2), the probabilities of the occurrence of other winning combinations resulting in prizes are left different between the first and second gaming machines as a matter of course, because the first and second gaming machines are different in the types and arrangement of the symbols. One reason to structure the gaming system in this way is that, being different from the special payout, the resource based on which a prize resulting from another winning combination is not paid based on data which is accumulation of a part of betting and is stored in the storage unit. The payout is determined based on a payout table stored in each of the gaming machines A1 and A2 in advance and does not have a correlation with another gaming machine, and hence one problem to be solved by the present invention, i.e., a problem that credits collected at the same rate and commonly accumulated in the storage unit for the special payout are awarded at unfair probabilities, does not occur in the cases of the other winning combinations. Another reason to structure the gaming system as above is that, the gaming system of the present embodiment is a new gaming system in which, while the base game for randomly determining the symbols is diversified in accordance with the characteristics of the symbol determination of each of the gaming machines linked by the connection unit, the special payout awarded based on the linking by the connection unit is awarded at equal probabilities as the inequality between the gaming machines is corrected by the second random determination.

In the random determination method employing the second random determination above, as compared to the symbol random determination above, the symbol arrangement on the reels and a later-described weight of each symbol do not influence on the random determination for awarding a prize. When one of the prizes is won as a result of the random determination, the symbols stop in accordance with the rearrangement state associated in advance with that prize. For this reason, the winning probability is easily adjustable.

To be more specific, in the present embodiment, the random determination probabilities of the special payout in the first and second gaming machines A1 and A2 are arranged to be identical with the random determination probability of the special payout in the third gaming machine A3, but the disclosure is not limited to this arrangement. All of the first to third gaming machines A1, A2, and A3 may be set at the same predetermined random determination probability. The first and second gaming machines are equivalent to gaming machines each of which includes a control unit configured to award the linked progressive jackpot in the second random determination and the symbol random determination in the present invention. The third gaming machine A3 is equivalent to a gaming machine which performs symbol random determination for all special payouts in the base game (including the normal game and the chance game described later) without executing the second random determination, and determines whether to award the special payout based on the rearrangement state of the symbols stopped at the positions on the reels determined in the random determination. In this case, after the rearrangement positions of the symbols are determined, whether to award the linked progressive jackpot is determined. In the meanwhile, in the gaming machine having the control unit configured to execute the second random determination, whether to award the linked progressive jackpot is directly determined by the second random determination, before the rearrangement state of the symbols is determined.

The first to third gaming machines A1, A2, and A3 have symbol display devices A12, A22, and A32 on which a game result is displayed by variably displaying the symbols and then rearranging the symbols. The symbol display devices A12, A22, and A32 may include mechanical reels which are rotated by a mechanical operation, or include video reels which are rotating reel images. As a matter of course, the present invention is suitably employed in a gaming machine having mechanical reels, in which it is difficult to uniformize the above-described symbol characteristics.

The first to third gaming machines A1, A2, and A3 include control units A11, A21, and A31. The control units A11, A21, and A31 are programmed to execute processes A111 to A114, A211 to A214, A311, and A312 below. The processes A111, A211, and A311 are processes for determining the symbols to be rearranged on the symbol display devices A12, A22, and A32, by the symbol random determination in which the symbol random determination probabilities are different between the gaming machines A1, A2, and A3. The processes A112, A212, and A312 are processes for awarding the special payout based on the symbols rearranged by the symbol random determination.

Furthermore, the first and second gaming machines A1 and A2 are programmed to execute processes A113 and A213 and processes A114 and A214. The processes A113 and A213 are processes for executing the second random determination which is random determination executed with a predetermined probability different from the probabilities in the symbol random determination in the processes A111, A211, and A311. The processes A114 and A214 are processes for awarding the special payout based on the result of the second random determination.

As described above, the random determination probability in the second random determination is set so as to cause the random determination probabilities of the special payout in the first and second gaming machines A1 and A2 to be identical with the random determination probability in the third gaming machine A3. In the present embodiment, the mystery random determination which is performed after the chance game (in which the winning probability of the special payout of the present invention is higher than the winning probability in the normal game) in which the free game is executed once is equivalent to the second random determination. When a winning is achieved in the mystery random determination (second random determination), the linked progressive jackpot (special payout of the present invention) is awarded as a prize.

The first to third gaming machines A1, A2, and A3 include input devices A13, A23, and A33 which receive a bet operation to output a bet amount for executing a game. The server A4 further includes a calculation unit A43. The calculation unit A43 receives bet amounts from the gaming machines A1, A2, and A3 and calculates the special payout based on the bet amounts. The calculation unit A43 is connected with a display unit AS via the display control unit A42. The display unit A5 is configured to display the special payout calculated by the calculation unit A43.

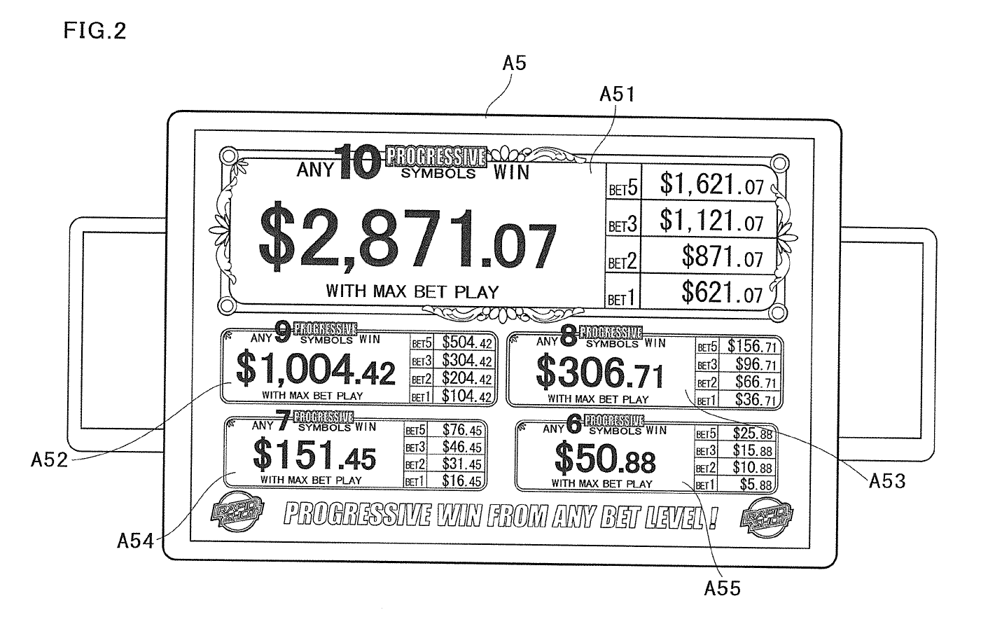

To be more specific, as shown in FIG. 2, the display unit AS outputs, as a display screen for the special payout, a display screen having first to fifth special payout display sections A51 to A55 as display areas. The first special payout display section A51 is provided at the upper most position on the display unit AS and occupies the largest area. the second special payout display section A52 and the third special payout display section A53 are provided below the first special payout display section A51 and on the left and right sides, respectively. The fourth special payout display section A54 and the fifth special payout display section A55 are provided below the second special payout display section A52 and the third special payout display section A53 and on the left and right sides, respectively.

The first special payout display section A51 indicates payout amounts paid out when ten jackpot symbols are rearranged 10. This display section shows the payout amount in case of the maximum betting in the largest area, and shows the payout amounts in cases of the 5, 3, 2, and 1 bets in small areas. The second special payout display section A52 shows payout amounts when nine jackpot symbols are rearranged, and displays, in a manner similar to the first special payout display section A51, payout amounts in cases of the maximum betting, 5 bets, 3 bets, 2 bets, and 1 bet. The third special payout display section A53 shows payout amounts when eight jackpot symbols are rearranged, and displays, in a manner similar to the first special payout display section A51, payout amounts in cases of the maximum betting, 5 bets, 3 bets, 2 bets, and 1 bet. The fourth special payout display section A54 shows payout amounts when seven jackpot symbols are rearranged, whereas the fifth special payout display section A55 shows payout amount when six jackpot symbols are rearranged.

### Gaming System: Server A4

The server A4 is configured to calculate the special payout constituted by the progressive jackpot based on the bet amounts on the gaming machines A1, A2, and A3, and display the special payout on the display unit A5. Furthermore, the server A4 is configured to send the special payout to each of the first to third gaming machines A1, A2, and A3 and cause each gaming machine to display the special payout. In the present embodiment, the server A4 has not only the functions of calculating and displaying the special payout but also a function of serving as a center controller for controlling the entire gaming system. The disclosure, however, is not limited to this arrangement, and the server A4 may be a dedicated server for calculating and displaying the special payout, or one of the gaming machines connected to the connection unit may be selected as a host and function as the server.

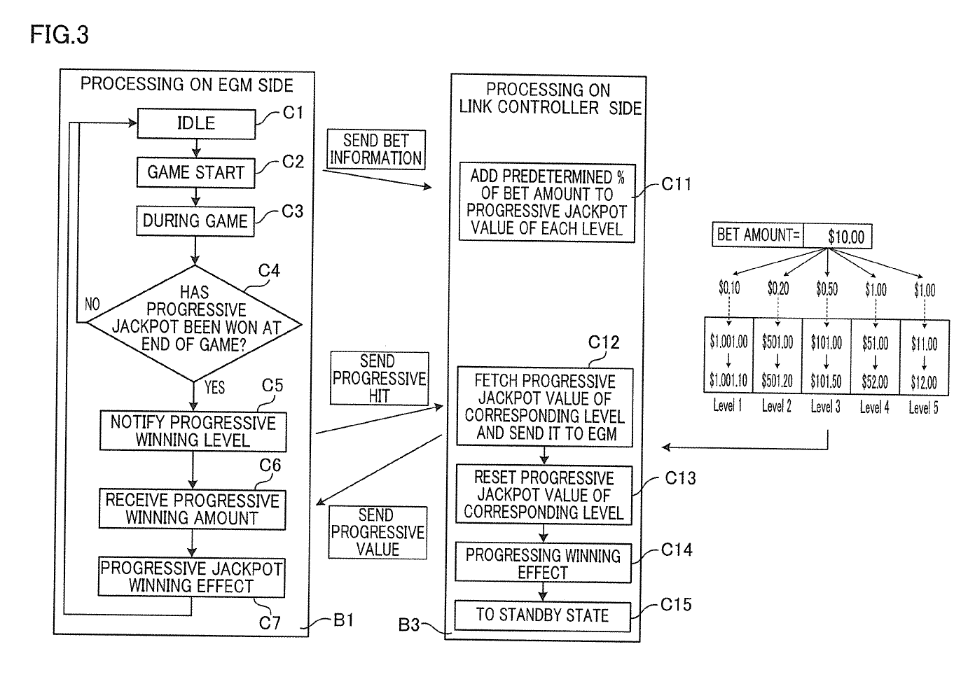

Specifically, as shown in FIG. 3, the server A4 stores an increment value for each progressive level, and adds up, as a progressive value, a value calculated by multiplying a bet amount supplied from each of the first to third gaming machines A1, A2, and A3 by the increment value. The progressive value calculated by the server A4 is displayable on each of the first to third gaming machines A1, A2, and A3 and the display unit A5 which is a signage.

To detail the operations of the server A4 and the first to third gaming machines A1, A2, and A3, to begin with, in the first to third gaming machines A1, A2, and A3, a game starts (C2) when each gaming machine is in an idle state (C1), and bet information is sent to the server A4 and at the same time the game is executed. When the game ends (C4) after the game is executed (C3), the step C1 is executed again if the progressive jackpot has not been won (C4: NO). In the meanwhile, when the progressive jackpot has been won (C4: YES), a progressive winning level (Progressive Hit) is notified (C5). Thereafter, a progressive winning amount (progressive value) is received from the server A4 (C6), and the progressive winning amount is displayed on a second screen 131 and an effect of the progressive jackpot is executed (C7).

Basically, the server A4 is arranged to perform an operation after receiving a command from the first to third gaming machines A1, A2, and A3, and is in a standby state in other cases. In the standby state, the progressive jackpot value of each level is displayed.

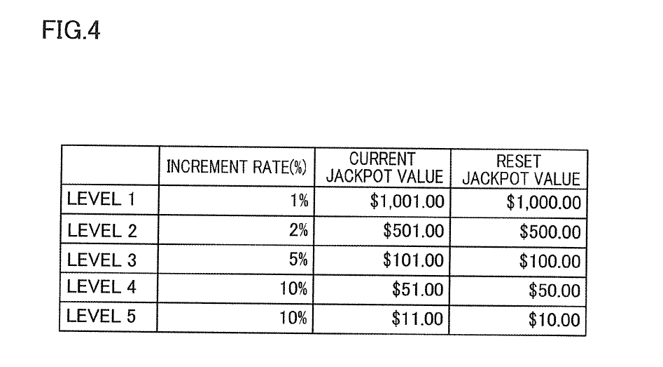

Upon receiving the bet information from the first to third gaming machines A1, A2, and A3, a predetermined percent of the bet amount is added to the progressive jackpot of each level (C11). Assume, for example, that bet amounts, increment rate setting, and a current progressive jackpot value are as shown in FIG. 4. That is to say, assume that an increment rate (%), a current jackpot value, and a jackpot reset value are 1%, $1,001.00, and $1,000.00 in the level 1, 2%, $501.00, and $500.00 in the level 2, 5%, $101.00, and $100.00 in the level 3, 10%, $51.00, and $50.00 in the level 4, and 10%, $11.00, and $10.00 in the level 5.

In the case above, to begin with, a value is calculated by multiplying the bet amount by each increment rate (%) (Process 1). That is to say, when the bet amount is $10.00, the value is $0.10 as $10.00 is multiplied by 1% in FIG. 4, in the case of the level 1. In the case of the level 2, the value is $0.20 as $10.00 is multiplied by 2% in FIG. 4. Similarly, the values are calculated by the multiplication by the increment rates (%) for the level 3, the level 4, and the level 5.

Subsequently, the value calculated in the process 1 is added to the current jackpot value (Process 2). That is to say, when the current jackpot value is $1,001.00 in the level 1, $0.10 is added to this value and $1,001.10 is obtained. When the current jackpot value is $501.00 in the level 2, $0.20 is added to this value and $501.20 is obtained. In similar manners, the value calculated in the process 1 is added to the current jackpot values of the level 3, the level 4, and the level 5.

Thereafter, upon receiving a winning level from each of the first to third gaming machines A1, A2, and A3, a progressive jackpot value corresponding to that level is fetched and sent to the first to third gaming machines A1, A2, and A3 (C12). For example, when the level-3 progressive jackpot is won, the value corresponding to the level 3 is fetched (Process 3). Then the fetched value is sent to the first to third gaming machines A1, A2, and A3. In so doing, the progressive jackpot value (e.g., $7.37) is displayed for the display unit A5. Thereafter, the progressive jackpot value corresponding to the level is reset (C13). That is to say, after the value corresponding to the level 3 is fetched, the value corresponding to the level 3 is set at a reset value (fixed value). For example, the value $101.50 is changed to $100.00 which is the reset value (fixed value). The other levels are not reset. Subsequently, after the progressive winning effect is executed (C14), the process is shifted to the standby state (C15).

### Gaming System: Gaming Machines

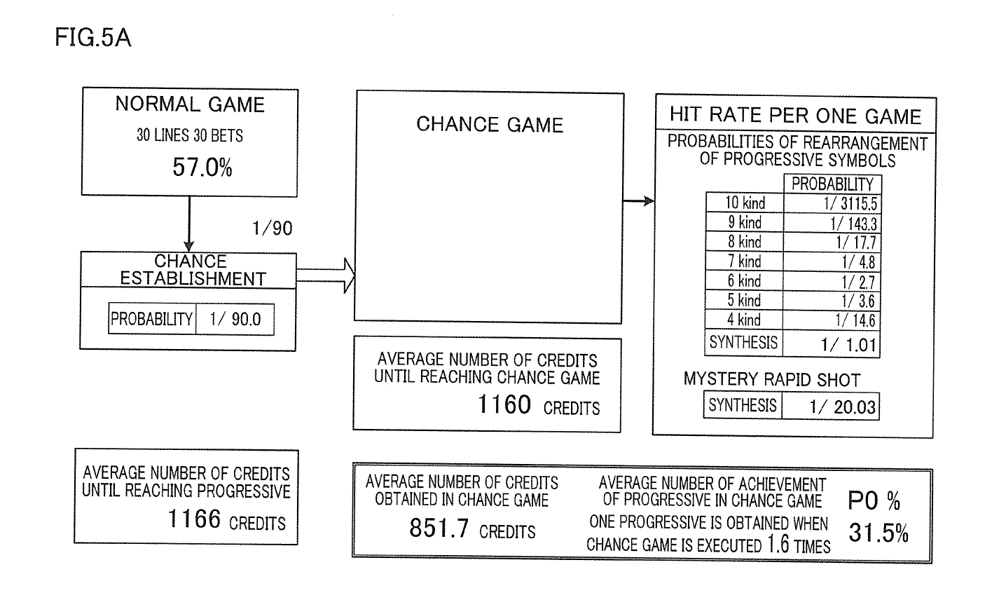

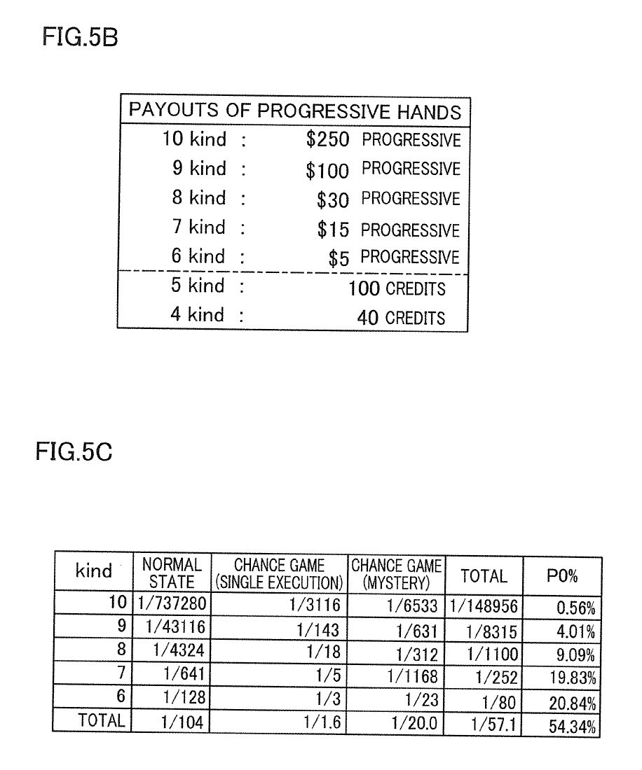

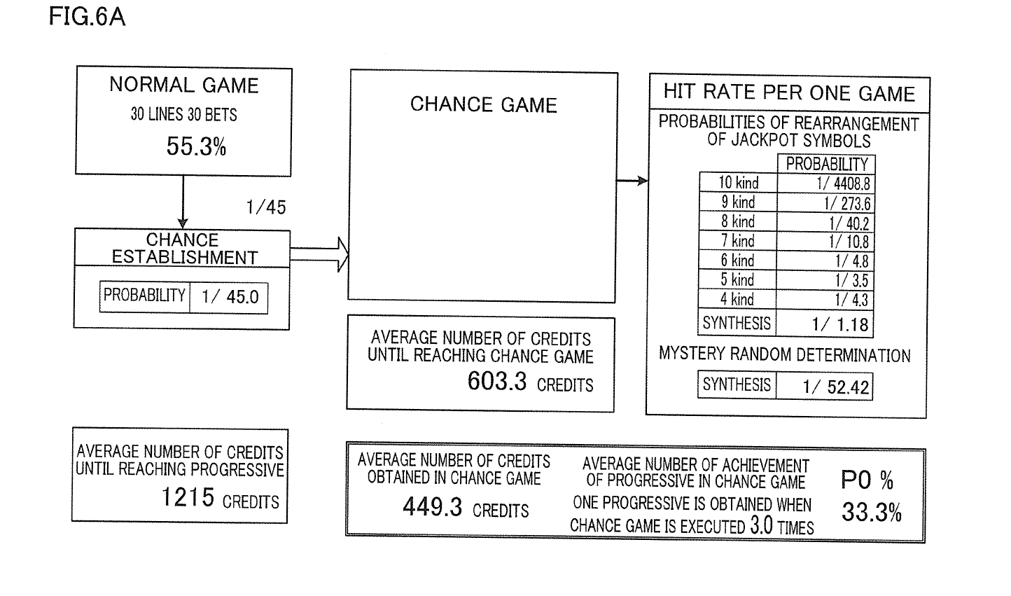

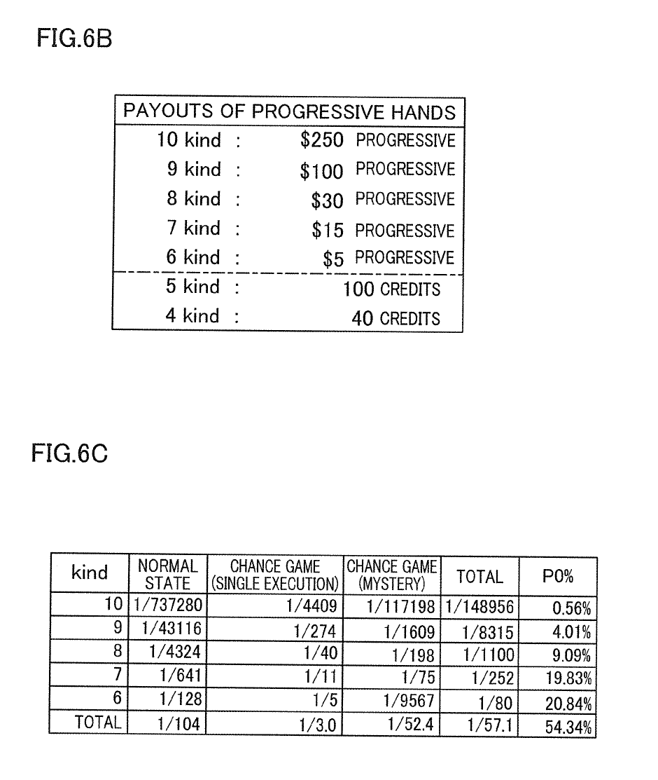

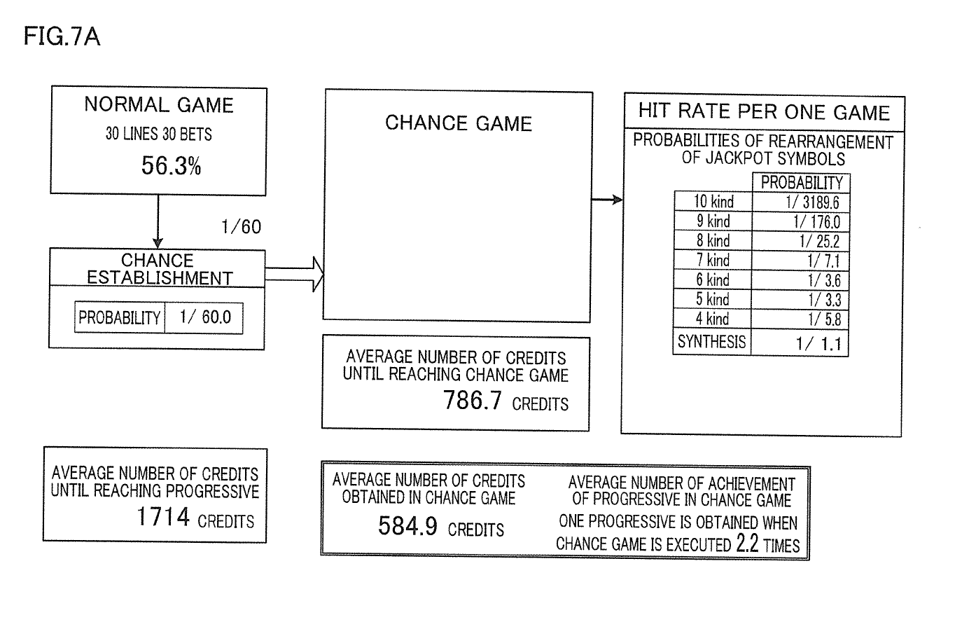

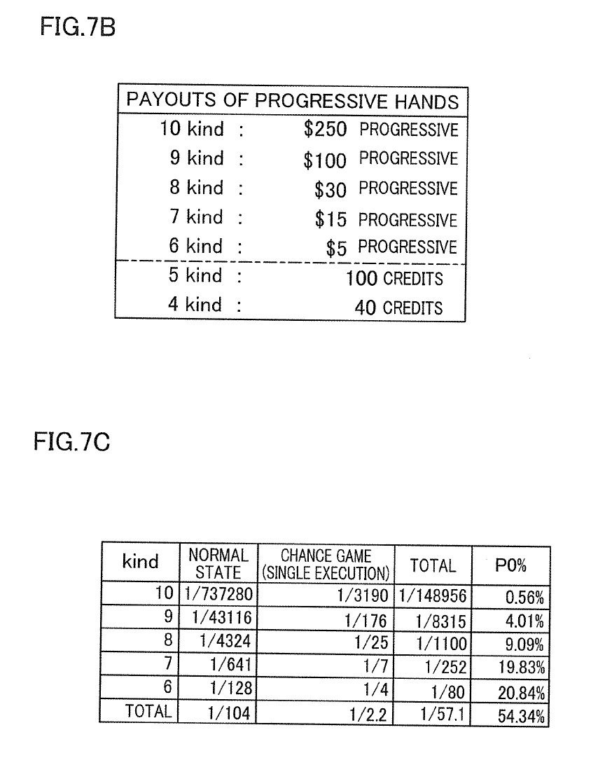

The first to third gaming machines A1, A2, and A3 above will be detailed with reference to specific values such as the random determination probabilities. While the first to third gaming machines A1, A2, and A3 having different gaming characteristics, i.e., the first gaming machine A1 shown in FIG. 5A to FIG. 5C, the second gaming machine A2 shown in FIG. 6A to FIG. 6C, and the third gaming machine A3 shown in FIG. 7A to FIG. 7C will be described below, the disclosure is not limited to this.

### Gaming System: First Gaming Machine A1

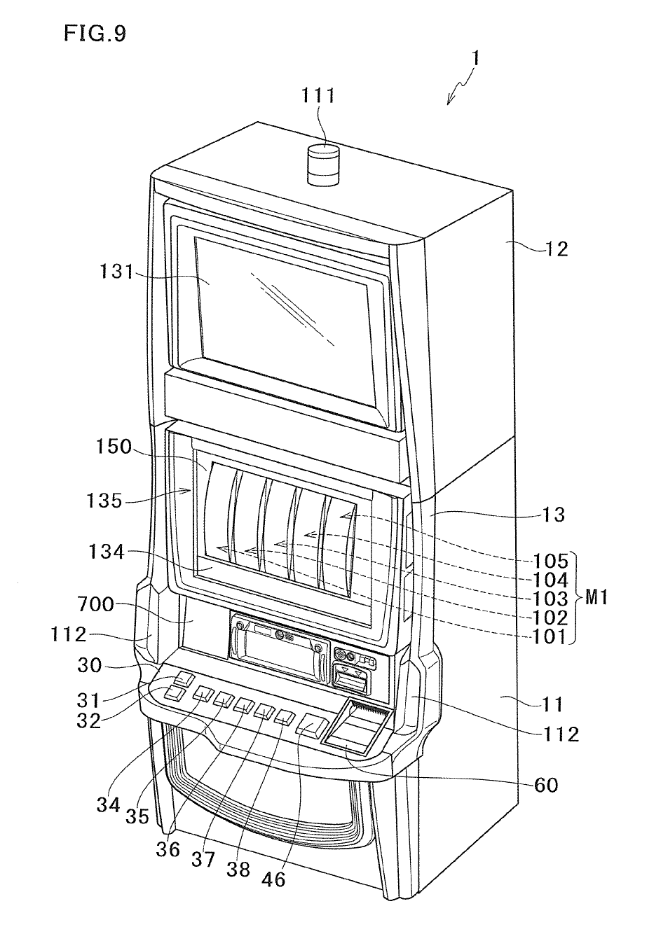

As shown in FIG. 5A, the first gaming machine A1 is arranged such that the normal game has a game specification of 30 lines and 30 bets and the payout rate is 57.0%. In the first gaming machine A1, the shifting to the chance game occurs at the probability of 1/90 (the chance game is a gaming state in which the winning probability of the special payout is higher than the winning probability in the normal game). The chance game is triggered when the bonus symbol is rearranged on the third reel 103 shown in FIG. 9, and is single execution of the free game requiring no betting. An average number of credits until reaching the chance game is 1160.

During the chance game, the control unit A11 performs control so that the jackpot symbol is easily rearranged and the special payout is easily awarded as compared to the normal game, and the control unit A12 performs control so that, after the chance game, the mystery random determination which is the second random determination of the present invention is always executed. The control unit A22 of the later-described second gaming machine A2 also performs the mystery random determination at the same timing.

In the normal game and the chance game, the control unit A11 performs control so that the jackpot symbols are rearranged by the above-described symbol random determination and the special payout is awarded, and the jackpot symbols are rearranged also by the above-described mystery random determination. In the present embodiment, the special payout is awarded when six or more jackpot symbols are rearranged on the symbol display device. This, however, may be suitably altered such that the special payout is awarded when N (which is at least one) jackpot symbols are rearranged.

As shown in FIG. 5A, the mystery random determination is executed by using a later-described table shown in FIG. 17, in the present embodiment. In the chance game of the present invention in which the winning probability of the special payout is higher than that in the normal game, the probability of winning the linked progressive jackpot in the mystery random determination (second random determination) is 1/20.03. In the first gaming machine of the present embodiment, a fixed payout is awarded when four or more jackpot symbols are rearranged (i.e., four or more jackpot symbols appear on the symbol display device), and the fixed payout and the special payout are awarded when six or more jackpot symbols are rearranged. The synthetic probability of the rearrangement of the jackpot symbols is therefore 1/1.01.

As shown in FIG. 5C, under the control of the control unit A11 of the first gaming machine of the present embodiment, the probability of the rearrangement of the jackpot symbols in the entirety of the normal game, the chance game, and the mystery random determination, i.e., the total probability of the rearrangement of six to ten kinds of jackpot symbols on the symbol display device is set at 1/57.1. This total probability of 1/57.1 is synthesis of the probability of 1/104 in the normal game, the probability of 1/1.6 for achieving 6 kinds or more in the chance game, and the probability of 1/20 for the winning in the mystery random determination. The first decimal place is rounded up.

In the later-described second gaming machine, the probability of achieving the special payout in the mystery random determination (second random determination) similar to the above is 1.91%, and under the control of the control unit A11 of the first gaming machine, the probability of the rearrangement of the jackpot symbols in the normal game, the chance game, and the mystery random determination, i.e., the total probability of the rearrangement of six to ten jackpot symbols on the symbol display device is set at 1/57.1. As clearly indicated by this, the probabilities of the rearrangement of the jackpot symbols in the first gaming machine and the second gaming machine are both 1/57.1 when the first decimal place is rounded up. In this way, the probabilities of the rearrangement of six or more jackpot symbols (i.e., the probabilities of the achievement of 6 kinds or more based on the jackpot symbols on the symbol display device) are arranged to be identical. Which decimal place the rounding is taken place to cause the probabilities to be identical is determined based on the regulations for the gaming machine in each country regarding the rounding, and is not always completely identical between the countries. In the later-described third gaming machine A3, being different from the first and second gaming machines, the mystery random determination is not performed after the chance game, and the random determination for achieving the special payout is always the above-described symbol random determination controlled by the control unit A31. However, because the winning probability of the special payout in the normal game is 1/104, the winning probability of the special payout in the chance game is 1/2.2, and the probability of the rearrangement of the jackpot symbols (i.e., probability of achieving the display state of 6 kinds or more based on the jackpot on the symbol display device) probability is 57.1, the winning probability of the special payout is identical with those in the first and second gaming machines.

An average number of credits until reaching the chance game is 851.7, and one progressive is obtained when the chance game is executed 1.6 times. The payout rate (PO %) is 31.5%. As shown in FIG. 5B, the payouts of the respective progressive hands are 40 credits in case of 4 kinds, 100 credits in case of 5 kinds, 5 credits in case of 6 kinds, 15 credits in case of 7 kinds, 30 credits in case of 8 kinds, 100 credits in case of 9 kinds, and 250 credits in case of 10 kinds. As a result, as shown in FIG. 5C, the total winning probability of 6 kinds to 10 kinds in the linked progressive jackpot in the normal game is 1/104. The winning probability of the linked progressive jackpot in the chance game (single execution of the free game) is 1/1.6. The winning probability of the linked progressive jackpot in the chance game (mystery random determination) is 1/20.0.

On account of the above, the probability of winning the linked progressive jackpot from the viewpoint of the normal game by winning the chance game at the probability of 1/90 in the normal game and winning the linked progressive jackpot at the probability of 1/1.6 in the chance game is 1/144. Furthermore, the probability of winning the linked progressive jackpot from the viewpoint of the normal game by winning at the probability of 1/20.0 the mystery random determination (second random determination) after the chance game, which is executed at the probability of 1/90 in the normal game, is 1/1800. The total winning probability calculated from the winning probability (1/144) in the chance game, the winning probability (1/1800) in the mystery random determination, and the winning probability (1/104) in the normal game is about 1/57.1. The payout rate is 54.34%.

### Gaming System: Second Gaming Machine A2

As shown in FIG. 6A, the second gaming machine A2 is arranged such that the normal game is executed with a game specification of 30 lines and 30 bets and the payout rate in the normal game is 55.3%. In the second gaming machine A2 the shifting to the chance game occurs at the probability of 1/45. The chance game is triggered when bonus symbols are rearranged on the third reel 103 shown in FIG. 9, and is single execution of the free game requiring no betting. An average number of credits until reaching the chance game is 603.3. During the chance game, the jackpot symbols are easily rearranged, and in the mystery random determination after the chance game, the linked progressive jackpot is won at the probability of 1.91%. The total probability of the rearrangement of the jackpot symbols is 1/1.18 for 6 kinds to 10 kinds. The probability of achieving the linked progressive jackpot (which is mystery rapid shot equivalent to the second random determination of the present invention) in the mystery random determination (second random determination) in the chance game is 1/52.42.

An average number of credits obtained in the chance game is 449.3, and one progressive is obtained when the chance game is executed 3.0 times. The payout rate (PO %) is 33.3%. As shown in FIG. 6B, being similar to the first gaming machine A1, the payouts of the progressive hands are 40 credits in case of 4 kinds, 100 credits in case of 5 kinds, 5 credits in case of 6 kinds, 15 credits in case of 7 kinds, 30 credits in case of 8 kinds, 100 credits in case of 9 kinds, and 250 credits in case of 10 kinds. As a result, as shown in FIG. 6C, the total winning probability of the linked progressive jackpot of 6 kinds to 10 kinds in the normal game is 1/104. The winning probability of the linked progressive jackpot in the chance game (single execution of the free game) is 1/3.0. The winning probability of the linked progressive jackpot in the chance game (mystery random determination) is 1/52.4.

Because of the above, the chance game is won at the probability of 1/45 in the normal game, and in this chance game the linked progressive jackpot is achieved at the probability of 1/3.0. On this account, from the view point of the normal game, the probability of winning the linked progressive jackpot is 1/135. Furthermore, because the probability of achieving a winning in the mystery random determination (second random determination) after the chance game which is executed at the probability of 1/90 in the normal game is 1/52.4, the probability of winning the linked progressive jackpot from the viewpoint of the normal game is 1/2358. On this account, the total winning probability calculated by adding up the winning probability (1/135) in the chance game, the winning probability (1/2358) in the mystery random determination, and the winning probability (1/104) in the normal game is about 1/57.1. The payout rate is 54.34%. As a result, between the first and second gaming machines A1 and A2, the random determination probabilities of the linked progressive jackpot (special payout) is arranged to be identical by the mystery random determination.

### Gaming System: Third Gaming Machine A3

As shown in FIG. 7A, the third gaming machine A3 executes the normal game with a game specification of 30 lines and 30 bets, and the payout rate in the normal game is 56.3%. In the third gaming machine A3, the shifting to the chance game occurs at the probability of 1/60. The chance game is triggered when bonus symbols are rearranged on the third reel 103 shown in FIG. 9, and is single execution of the free game requiring no betting. An average number of credits until reaching the chance game is 786.7. The jackpot symbols are easily rearranged in the chance game. The total probability of the rearrangement of the jackpot symbol is 1/1.1 for 6 kinds to 10 kinds. The probability of winning the linked progressive jackpot (which is the mystery rapid shot equivalent to the second random determination in het present invention) based on the mystery random determination(second random determination) in the chance game is 0.

An average number of credits obtained in the chance game is 584.9, and one progressive is obtained when the chance game is executed 2.2 times. As shown in FIG. 7B, being similar to the first and second gaming machine A2, the payouts of the progressive hands are 40 credits in case of 4 kinds, 100 credits in case of 5 kinds, 5 credits in case of 6 kinds, 15 credits in case of 7 kinds, 30 credits in case of 8 kinds, 100 credits in case of 9 kinds, and 250 credits in case of 10 kinds. As a result, as shown in FIG. 7C, the total winning probability of the linked progressive jackpot of 6 kinds to 10 kinds in the normal game is 1/104. The winning probability of the linked progressive jackpot in the chance game (single execution of the free game) is 1/2.2.

As a result, because the chance game is won at the probability of 1/60 in the normal game and the linked progressive jackpot is won at the probability of 1/2.2 in the chance game, the total winning probability calculated by adding the winning probability (1/132) in the chance game to the winning probability (1/104) in the normal game is 1/57.1. The payout rate is 54.34%. As such, because the first and second gaming machines A1 and A2 execute the mystery random determination, the first to third gaming machines A1, A2, and A3 are identical with one another in the total winning probability.

The regulations for casino gaming devices are set in countries. For a gaming system in which the special payout is awarded to linked gaming machines as in the present invention, some countries have a regulation that the probability of obtaining the special payout in each gaming machine must be identical between all of the linked gaming machines.

### Gaming System: Definitions

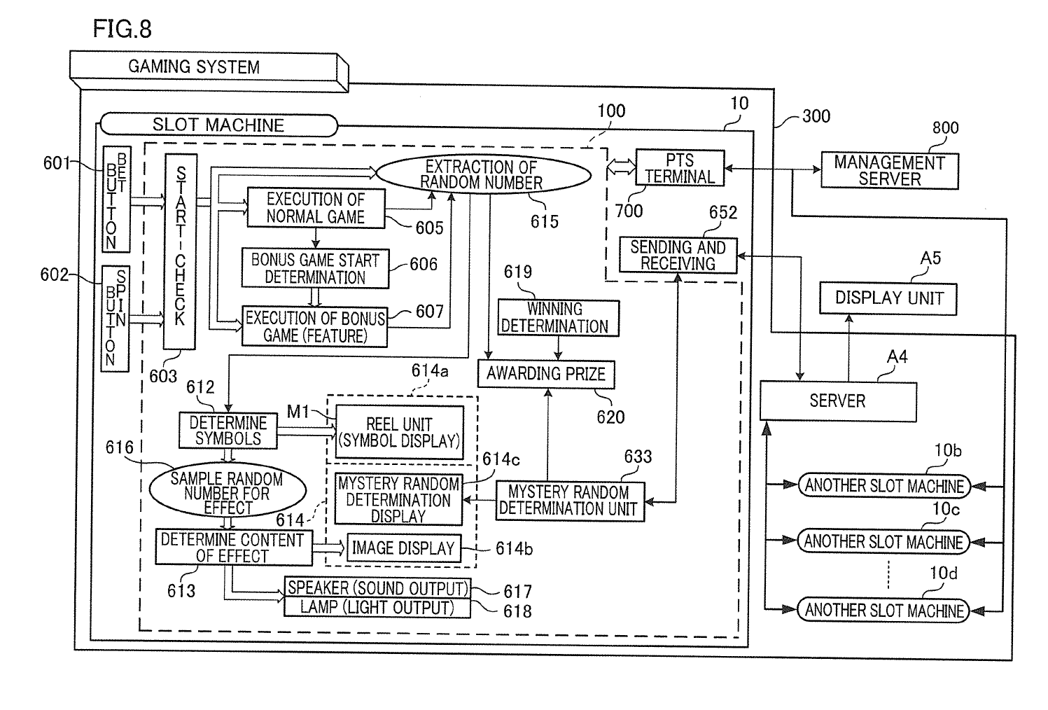

Gaming machines such as the first to third gaming machines A1, A2, and A3 above are incorporated in a gaming system 300 shown in FIG. 8.

The gaming machine is a kind of the gaming terminals in the gaming system 300. In the present embodiment, the gaming machine linked to the server by the connection unit is taken as an example of a gaming terminal, but the disclosure is not limited to this. An apparatus having a game controller 100 which is able to award a special payout without the intervention of a server may be used as a gaming terminal.

A base game of the present embodiment is run by the gaming machine. The base game is a slot game of rearranging a plurality of symbols, and encompasses a normal game and a chance game. In this base game, the linked progressive jackpot (special payout) may be won. After the chance game, the mystery random determination(second random determination) is executed to randomly determined the number of jackpot symbols, and the linked progressive jackpot may be won.

The rearrangement of the symbols in the slot game is conducted on mechanical reels which form a symbol display device M1. In the slot game, the chance game in which the free game is executed once as a bonus game is executed. In the chance game, the free game may be executed not once but plural times.

While the present embodiment deals with the slot game in which the normal game and the chance game are executed, in the slot game a bonus game different from the chance game may be executed in place of or in addition to the chance game. For example, the slot game may include a process of rearranging symbols in a condition in which the payout rate is higher than the payout rate in the normal game and a process of executing a bonus game of awarding a bonus payout in accordance with the rearranged symbols. Furthermore, the slot game may include a process of executing a rescue process when a rescue start condition is established.

Symbols are constituted by a specific symbol and a normal symbol. In other words, “symbol” is a superordinate concept to the specific symbol and the normal symbol. The specific symbol includes a bonus symbol and a jackpot symbol. The bonus symbol functions as a trigger of the execution of the chance game. The symbols will be detailed later.

A coin, a bill, or electrically valuable information corresponding to these is used as a game value. Note that the game value in the present invention is not particularly limited. Examples of the gaming value include game media such as medals, tokens, cyber money, tickets, and the like. A ticket is not particularly limited, and a later-mentioned barcoded ticket may be adopted for example. Alternatively, the game value may be a game point not including valuable information.

The “free game” is a game runnable with a bet of fewer game values than the normal game. Note that “bet of fewer amounts of game values” encompasses a bet of zero (0) gaming value.

Therefore, the free game may be a game which is run without betting a gaming value and the game value is paid out for an amount corresponding to rearranged symbols. In other words, the “free game” may be a game which is started without consumption of a game value. To the contrary, the “normal game” is a game runnable on condition that a game value is bet, which normal game awards an amount of game value based on the symbols rearranged. In other words, the “normal game” is a game which starts with consumption of a game value.

The expression rearrangement in this specification means dismissing an arrangement of symbols, and arranging symbols once again. Arrangement means a state where the symbols can be visibly confirmed by a player. More specifically, “rearrangement” is a state in which, after the symbols on the reels are variably displayed as the reels rotate, the variable display of the symbols stops as the rotation of the reels stops, and the symbols stop in the display window.

The phrase “normal payout based on the rearranged symbols” indicates a normal payout corresponding to a winning combination resulting from the rearrangement. The phrase “bonus payout based on the rearranged symbols” indicates a bonus payout corresponding to a winning combination resulting from the rearrangement. It is noted that the term “winning combination” indicates that a prize is established.

### Gaming System 300: Details

As shown in FIG. 8, the following will describe the gaming system 300 in which gaming machines 10a to 10d are linked. The gaming machines 10a to 10d are provided in a multi-player gaming system 300. The gaming system 300 is arranged such that the gaming machines 10a to 10d each of which is a gaming terminal including a reel unit M1 are connected with the server A4 to be able to perform data communications therewith. The gaming system 300 allows a base game such as a slot game to be executable in each of the gaming machines 10a to 10d. Furthermore, in the gaming system 300, the linked progressive jackpot is awarded as a prize at the same probability between the gaming machines 10a to 10d.

The gaming system 300 may be arranged such that a common game is executable as the gaming machines 10a to 10d are in sync with one another. The gaming machines 10a to 10d are connected with the server A4 by wire, wireless, or a combination of these two. A unit of bet amount may be a currency of a country or area such as dollar, yen, euro, or the like, or may be a game point used exclusively in a hall having the gaming system 300 or in the industry.

To be more specific, the gaming system 300 includes the gaming machines 10a to 10d and the server A4 connected with the gaming machines 10a to 10d to be able to perform data communications therewith. The server A4 is connected with the gaming machines 10a to 10d installed in a hall to be able to perform data communications therewith.

Each of the gaming machines 10a to 10d includes a BET button 601, a spin button 602, and a reel unit M1 (symbol display device), and further includes a game controller 100 configured to control these units. The BET button 601 and the spin button 602 are kinds of input devices. Furthermore, each of the gaming machines 10a to 10d includes a transceiver unit 652 which allows the gaming machine to perform data communications with the server A4.

The BET button 601 above has a function of receiving a bet amount input by the player. The spin button 602 has a function of receiving an instruction to start a game such as a normal game in response to an operation by the player, i.e., a start operation. The display 614 has a function of displaying still image information such as various symbols, numbers, and characters and moving image information such as effect movies. Furthermore, the display 614 has a touch panel 69 as an input device, and has a function of receiving various instructions input by a pressing operation by the player. The display 614 includes a image display region 614b and a mystery random determination display region 614c.

The game controller 100 includes a start check unit 603, a normal game running unit 605, a bonus game start determining unit 606, a bonus game running unit 607, a random number sampling unit 615, a symbol determining unit 612, an effect-use random number sampling unit 616, an effect determining unit 613, a speaker unit 617, a lamp unit 618, a winning determining unit 619, and a prize awarding unit 620.

The normal game running unit 605 has a function of running a normal game when an operation of the BET button 601 is made. The bonus game start determining unit 606 determines whether to run a bonus game, based on a combination of the symbols rearranged in the normal game. That is to say, the bonus game start determining unit 606 has a function of determining that a chance game is obtained when a bonus symbol is rearranged, and transferring the process to the bonus game running unit 607 so that a chance game is run from the next unit game.

It is noted that “unit game” is a series of operations from the start of the receiving of a bet to a state in which an award can be established. For example, a unit game in the normal game includes a single bet time for receiving a bet, a single game time of rearranging stopped symbols, and a single payout time of a payout process of awarding a payout. A unit game in the normal game is termed unit normal game. The bonus game running unit 607 has a function of running a chance game in which a free game is executed only by an operation of the spin button 602.

The symbol determining unit 612 has functions of: determining symbols to be rearranged with reference to a random number from the random number sampling unit 615; rearranging the determined symbols on the reel unit M1; outputting rearrangement information of the symbols to the winning determining unit 619; and outputting an effect specifying signal to the effect-use random number sampling unit 616 based on the state of the rearrangement of the symbols.

The effect-use random number sampling unit 616 has a function of sampling an effect random number when receiving an effect instruction signal from the symbol determining unit 612 and a function of outputting the effect random number to the effect determining unit 613. The effect determining unit 613 has a function of determining the effect content by using an effect-use random number, a function of outputting the image information of the determined effect content to the image display region 614b of the display 614, and a function of outputting audio/light information of the determined effect content to the speaker unit 617 and the lamp unit 618.

The winning determining unit 619 has a function of determining the presence of a winning when obtaining rearrangement information of the symbols, a function of calculating a payout amount based on the winning combination when it is determined that winning is achieved, and a function of outputting a payout signal to the prize awarding unit 620 based on the payout amount. The prize awarding unit 620 has a function of paying out a game value to the player. Furthermore, the prize awarding unit 620 has a function of adding credit data corresponding to the credit to be paid out to the credit data stored in an IC card inserted into a later-described PTS terminal 700.

In addition to the above, the game controller 100 is provided with a mystery random determination unit 633. With this mystery random determination unit 633, the linked progressive jackpot may be won based on the mystery random determination at the end of the chance game.

In addition to the above, the game controller 100 is connected to the PTS terminal 700. The PTS terminal 700 is a unit in which an LCD, a microphone, a human detection camera, etc. are integrated, and has, for example, a function of executing an effect for a game by mutual communications with the game controller 100. In particular, the PTS terminal 700 has a card insertion slot to which an IC card can be inserted. This allows the player to insert an IC card into the card insertion slot and use credits stored in the IC card in the gaming machines 10a to 10d.

In addition to the above, when receiving credit data from the PTS terminal 700, the game controller 100 updates the credit display on the display 614. Furthermore, the game controller 100 outputs settled credit data too the PTS terminal 700 when the credits on a game are settled.

The PTS terminal 700 included in each of the gaming machines 10a to 10d constituting the gaming system 300 is connected with the management server 800 to be able to perform communications therewith, and controls the download of images and manages the IC card and credits.

### Outline of Gaming Machine

As shown in FIG. 9, the gaming machine 10 has five reels 101, 102, 103, 104, and 105 from left to right. The five reels 101 to 105 are mechanically controlled and stopped by an electric motor. The gaming machine 10 is arranged such that, on each of the five reels 101 to 105, the symbols stop on the upper stage, the central stage and the lower stage. When all of the five reels 101 to 105 stop, 15 symbols in total (=5reels×3 stages) are rearranged in the display window 150 of the symbol display unit 40.

The gaming machine 10 has 30 paylines in the display window 150. Whether a winning is achieved is determined based on the types and the number of the symbols lined up on a payline. In the gaming machine 10, 30 paylines are activated by the betting of 1 credit which is the minimum bet. In other words, 30 paylines are always active irrespective of the bet amount in the gaming machine 10 of the present embodiment, and the winning probability is always constant irrespective of the bet amount. The differences in the bet amounts are adjusted by proportionally adjusting the payout amounts. For example, when a prize is established on one payline, a payout amount of 10 bets is ten times as much as a payout amount of 1 bet.

The bet patterns of the gaming machine 10 are the following four patterns.
(1) 30, 60, 90, 120, 150,
(2) 30, 60, 90, 150, 300,
(3) 30, 60, 150, 300, 450,
(4) 30, 60, 150, 300, 600
   One of these four bet patterns is selected. The bet pattern is selected by, for example, a clerk of a gaming facility such as casino.

As described above, 30 paylines are always active. On this account, the bet amount on each payline is 1, 2, 3, 4, or 5 according to the first bet pattern. The bet amount on each payline is 1, 2, 3, 5, or 10 according to the second bet pattern. The bet amount on each payline is 1, 2, 5, 10, or 15 according to the third bet pattern. The bet amount on each payline is 1, 2, 5, 10, or 20 according to the fourth bet pattern. AS such, the maximum bet amounts on one payline in the four bet patterns are 5, 10, 15, and 20.

The symbols in the gaming machine 10 include RED7, BLUE7, 3BAR, 2BAR, 1BAR, JACKPOT, and BONUS. A winning is achieved when RED7, BLUE7, 3BAR, 2BAR, or 1BAR are arranged from left to right. Whether a winning is achieved is determined by the number of predetermined symbols lined up from left to right along a payline.

That is to say, a payout is determined based on the type and the number of the symbols lined up along a payline from the leftmost reel 101 toward the rightmost reel M105. On this account, even if the symbols are lined up along a payline from the reel M102, the reel M103, or the reel M104, no winning is achieved and no payout is awarded.

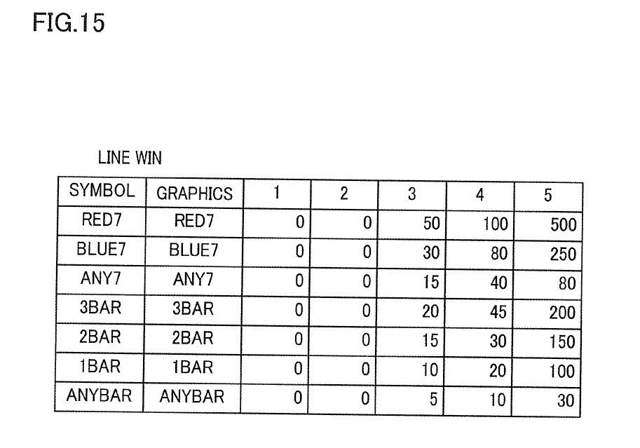

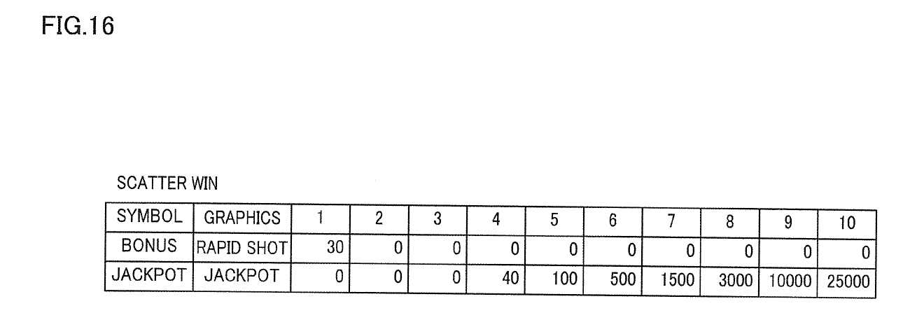

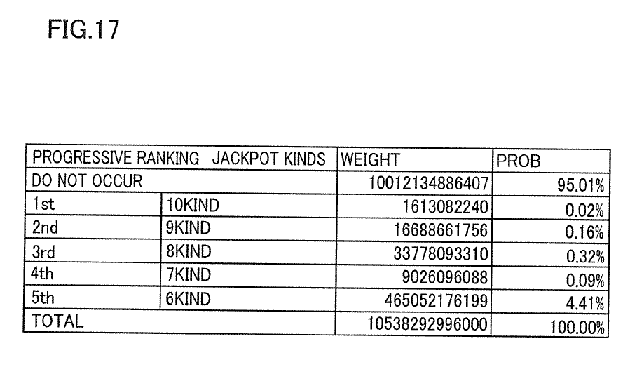

As shown in FIG. 15 and FIG. 16 described below, there are 9 types of winning patterns. The winning patterns will be detailed later. When two types of symbols of RED7 and BLUE7 are mixedly lined up on a payline, a predetermined payout of ANY7 is awarded. When two types of symbols of BLUE7 and RED7 are mixedly lined up on a payline, the predetermined payout of ANY7 is awarded.

When three types of symbols of 3BAR, 2BAR, and 1BAR are mixedly lined up on a payline, a predetermined payout of ANYBAR is awarded. When three types of symbols of 2BAR, 3BAR, and 1BAR are mixedly lined up on a payline, the predetermined payout of ANYBAR is awarded. When three types of symbols of 1BAR, 3BAR, and 2BAR are mixedly lined up on a payline, the predetermined payout of ANYBAR is awarded.

JACKPOT and BONUS (with the text “RAPID SHOT”) are scatter symbols. A winning is achieved when a predetermined number of JACKPOT or BONUS appear on the display window 150.

Two JACKPOT symbols are successively arranged in each reel over BLANK. BONUS is provided only in the third reel.

In the normal game mode, a free game trigger is established when the BONUS which is the scatter symbol appears in the display window 150, and the normal game mode is shifted to the free game mode which is the chance game.

In the free game mode, the free game is executable once and the JACKPOT is more likely to be established. Furthermore, in the free game mode, the re-trigger is established when BONUS appears in the display window 150, and one execution of the free game is added in the free game mode. When the free game mode ends without the establishment of the re-trigger, the mystery random determination (second random determination) is executed and the linked progressive jackpot becomes winnable.

The gaming machine 10 has a progressive function. With the progressive function, when the progressive is won with the rearrangement of 6 kinds or more (6 or more) JACKPOT symbols in the display window 150, the progressive value accumulated up to this point is paid out.

Each time the unit game is executed, the gaming machine 10 adds a predetermined accumulative amount to the progressive value. The progressive value which is paid out when the progressive is won indicates the total accumulative amount.

As described later, when 4 kinds or more (4 or more) JACKPOT symbols are rearranged in the display window 150, a payout (normal payout) corresponding to the number of kinds is awarded.

As described above, when 6 kinds or more (6 or more) JACKPOT symbols are rearranged in the display window 150, the progressive value is paid out. On this account, when 6 kinds or more (6 or more) JACKPOT symbols are rearranged in the display window 150, the progressive value is paid out in addition to the payout corresponding to the number of kinds. In other words, when 6 kinds or more JACKPOT are rearranged, both the payout corresponding to the number of kinds and the progressive value are paid out.

### Overall Structure of Gaming Machine

Now, the overall structure of the gaming machine 10 will be described. FIG. 9 shows the overall structure of the slot machine of the embodiment of the present invention.

In the gaming machine 10, electronic value information such as electronic money is used as a game value. The game value is not limited to this. For example, coins, medals, tokens, and tickets with barcodes may be employed.

The gaming machine 10 includes a cabinet 11, a top box 12 installed on the upper side of the cabinet 11, and a main door 13 provided at the front surface of the cabinet 11. The cabinet 11 is provided with a lamp 111.

The main door 13 is provided with a reel unit M1 (corresponding to symbol display device) constituted by five reels 101, 102, 103, 104, and 105. On the front surface of the reel unit M1 is provided a reel cover 135. On the front surface of the reel cover 135, a liquid crystal display device 134 by which a game status is notified to the player and a transparent panel are provided. This liquid crystal display device 134 is provided with a touch panel 137. The reel cover 135 has a display window 150 at the central portion. In accordance with the reels 101 to 105, the display window 150 displays one symbol in each of the upper stage, the middle stage, and the lower stage. To put it differently, 15 symbols forming a 5 by 3 matrix are displayed to be viewable in the display window 150. On the outer circumferential surface of each of the reels 101, 102, 103, 104, and 105, 22 symbols are depicted. These 22 symbols are lined up along the rotational direction of the reels 101, 102, 103, 104, and 105 to form a symbol column. Each of the symbol columns is a combination of “RED 7”, “BLUE 7”, “3BAR”, “2BAR”, “1BAR”, “JP”, and “BONUS”. The main door 13 is provided with a speaker 112.

Furthermore, in the gaming machines 10a to 10d, paylines are arranged for determining whether a winning is established by the symbols rearranged in the display window 150. In the present embodiment, there are 30 paylines in total.

The reel unit M1 rearranges the symbols on the display window 150 by drivingly rotating the reels 101, 102, 103, 104, and 105 each having the symbols on the outer circumferential surface. In the descriptions below, the reels may be referred to as a first reel 101, a second reel 102, a third reel 103, a fourth reel 104, and a fifth reel 105 from the left end in front elevation.

On the inner circumferential side of each of the reels 101, 102, 103, 104, and 105 arranged as above, a backlight unit (not illustrated) is provided. The backlight unit is arranged so that illuminating light is emitted from the inner circumferential side of the reels 101, 102, 103, 104, and 105 toward the outer circumferential surface side of the reels so that the illumination light passing through the outer circumferential surfaces of the reels is viewable from the outside of the display windows 150. The backlight unit is configured to be able to change the amount of illumination light in multiple stages. The degree of freedom in the effects using illumination light is therefore high. Furthermore, the backlight unit is able to emit light in multiple colors. The symbols are illuminated with the illumination light of the following colors.

It should be noted that the present embodiment deals with a case where each of the gaming machines 10a to 10d employs the reel unit M1 in the form of mechanical reels; however, the gaming machines 10a to 10d of the present invention may adopt video reels that display simulated reels, or adopt a combination of the video reels and the mechanical reels.

On the front surface of the top box 12 is provided an upper image display panel 131. The upper image display panel 131 is made up of a liquid crystal panel and constitutes a display. The upper image display panel 131 displays image concerning effects, an introduction to games, images for explaining rules of games, or the like. In the present embodiment, the upper image display panel 131 displays a progressive payout screen which indicates payout amounts of four types of progressive jackpots (equivalent to the progressive payouts.

Below the reel unit M1, a control panel 30 on which buttons are provided, a PTS device 700, and a bill entry 60 are provided.

The bill entry 60 validate bills and receives genuine bills into the cabinet 11. This bill entry 60 is electrically connected with the PTS device 700. When receiving a genuine bill, the bill entry 60 sends an input signal based on the amount of the bill to the PTS device 700. This input signal includes information such as credit data regarding the received bill.

The PTS device 700 is a unit in which a LCD (liquid crystal display), a human detection camera, a microphone, and the like are integrated. The human detection camera is configured to detect the presence of a player by a camera function. The microphone allows a player to participate in a game by sound or authorizes a player by voice recognition. The PTS device 700 is provided with a card insertion slot through which an IC card is inserted. This allows the player to insert an IC card into the card insertion slot and use credits stored in the IC card in the gaming machine 10.

### Control Panel 30

On the control panel 30, a HELP button 31 and a CASHOUT button 32 are provided in the left side area, a 30-BET button 34, a 60-BET button 35, a 90-BET button 37, a 150-BET button 38, and a 300-BET button 39 are provided in the central area, and a spin button 46 is provided in the right side area.

The help button 31 is pressed when, for example, it is unclear how to play a game. As the help button 31 is pressed, various help information is displayed on a liquid crystal display device 134. The cashout button 32 is an operation button to be used for cashing out credits stored in the gaming machine 10.

The 30-bet button 34 is used for placing a bet of 30 credits out of the credits owned by the player, every time it is pressed. The 60-bet button 35 is used for starting the game with a bet of 60 credits. The 90-bet button 37 is used for starting the game with a bet of 90 credits. The 150-bet button 38 is used for starting the game with a bet of 150 credits. The 300-bet button 39 is used for starting the game with a bet of 300 credits. As such, the bet amount on each active payline is determined by pressing the 30-BET button 34, the 60-BET button 35, the 90-BET button 37, the 150-BET button 38, or the 300-BET button 39. The spin button 46 is used to start the scroll of the reels 101, 102, 103, 104, and 105.

### Electrical Configuration of Slot Machine

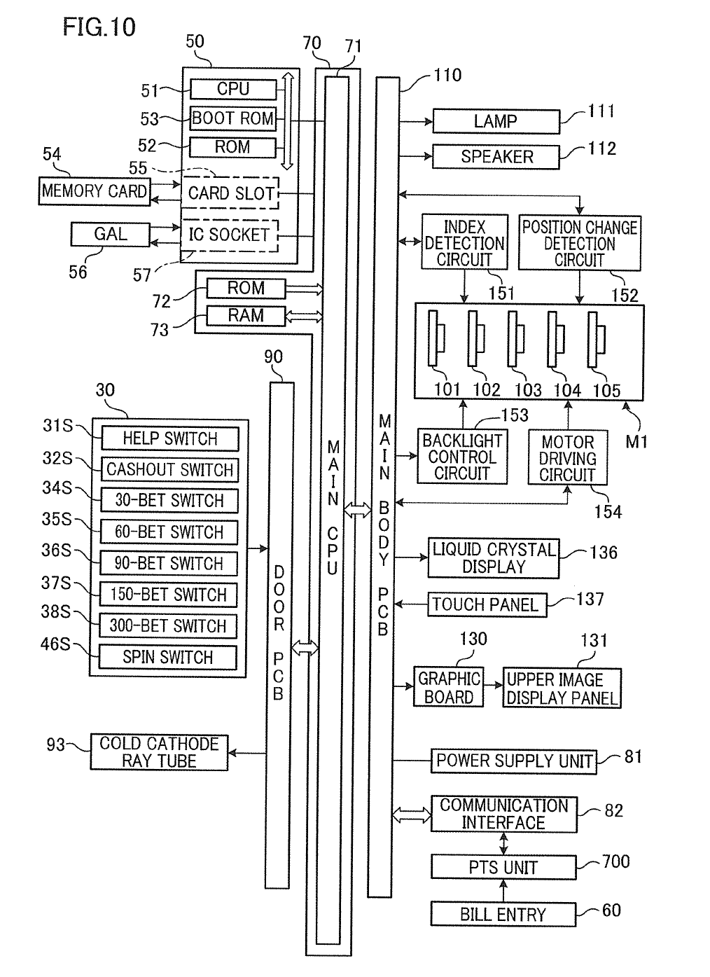

The following describes a circuitry structure of the slot machine, with reference to FIG. 10. FIG. 10 is a block diagram showing an internal structure of the slot machine of the embodiment of the present invention.

A gaming board 50 is provided with a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression, a random determination program and and a program for producing effects by images and sounds.

Further, the card slot 55 is configured so that the memory card 54 can be inserted thereinto and removed therefrom, and is connected to a motherboard 70 by an IDE bus. The type and contents of the game to be played on the gaming machines 10a to 10d can be changed by drawing out the memory card 54 from the card slot 55, writing another game program into the memory card 54, and inserting the memory card 54 into the card slot 55.

The GAL 56 is a type of PLD (programmable Logic Device) having a fixed OR array structure. The GAL 56 is provided with a plurality of input ports and output ports, and a predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the gaming machines 10a to 10d can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 are equivalent to storages.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations in execution of these programs. Examples of the areas include: an area that stores counters for the number of games, the bet amounts, the credit amounts, the progressive payouts and each payout values, and an area that stores symbols (code numbers) randomly determined.

Furthermore, the RAM 73 stores various types of data tables which will be described later. The communication interface 82 is provided for communicating with the PTS device 700 and an unillustrated external controller. Upon receiving the input signal from the bill entry 60, the PTS device 700 sends the credit data in the input signal to the main CPU 71 via the communication interface 82. When the IC card is inserted into the card insertion slot, the PTS device 700 sends the credit data stored in the IC card to the main CPU 71 via the communication interface 82. Furthermore, based on the control signal received from the main CPU 71 via the communication interface 82, the PTS device 700 writes credit data into the IC card inserted into the card insertion slot.

Further, the motherboard 70 is connected with a door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71. The door PCB 90 is connected with a control panel 30 and a cold cathode tube 93.

The control panel 30 is provided with a HELP switch 31S, a CASHOUT switch 32S, a 30-BET switch 34S, a 60-BET switch 35S, a 90-BET switch 37S, a 150-BET switch 38S, a 300-BET switch 39, and a spin switch 46S to correspond to the respective buttons. Each of the switches outputs a signal to the main CPU 71 upon detection of the pressing of the button corresponding thereto by the player.

The cold cathode tube 93 functions as a backlight installed on the rear face side of the upper image display panel 131, and lights up based on a control signal output from the main CPU 71.

The main PCB 110 is connected with a lamp 111, a speaker 112, a graphic board 130, a liquid crystal display device 136, a touch panel 137, an index detection circuit 151, a position change detection circuit 152, a backlight control circuit 153, and a motor driving circuit 154. The index detection circuit 151, the position change detection circuit 152, the backlight control circuit 153, and the motor driving circuit 154 are connected to the reel unit M1.

The lamp 111 is turned on based on a control signal output from the main CPU 71. The speaker 112 outputs sounds such as BGM, based on a control signal outputted from the main CPU 71.

The graphic board 130 controls image display executed by the upper image display panel 131 based on a control signal outputted from the main CPU 71. The graphic board 130 is provided with a VDP (Video Display Processor) generating image data, a video RAM temporarily storing the image data generated by the VDP, and the like. It is to be noted that the image data used in generation of image data by the VDP is included in the game program that has been read from the memory card 54 and stored into the RAM 73.

The liquid crystal display device 136 displays an image based on a control signal output from the main CPU 71. The touch panel 137 detects a place on the liquid crystal display device 136 touched by the player's finger or the like, and outputs to the main CPU 71 a signal corresponding to the detected place.

The motor driving circuit 154 is connected to a stepper motor that rotates the reels 101, 102, 103, 104, and 105. The motor driving circuit 154 is provided with a FPGA (Field Programmable Gate Array) 155 and a driver. The FPGA 155 is a programmable electronic circuit such as LSI and functions as a control circuit of the stepper motor. The driver 154 functions as an amplifying circuit for amplifying a pulse input to the stepper motor.

The index detection circuit 151 detects the positions of the rotating reels 101, 102, 103, 104, and 105 and is able to detect the step out of the reels 101, 102, 103, 104, and 105.

The position change detection circuit 152 detects a change in the stop positions of the reels 101, 102, 103, 104, and 105 after the rotation of the reels 101, 102, 103, 104, and 105 is stopped. The position change detection circuit 152 detects a change in the stop positions of the reels 101, 102, 103, 104, and 105 when, for example, a stop position is changed to achieve a winning combination of the symbols by an illicit way when no winning combination of the symbols is achieved. The position change detection circuit 152 is configured to be able to detect a change in the stop positions of the reels 101, 102, 103, 104, and 105 by, for example, detecting unillustrated fins attached at predetermined intervals to the inner circumferential part of each of the reels 101, 102, 103, 104, and 105.

The method of magnetic excitation of the stepper motor is not particularly limited; 1-2 phase excitation or 2 phase excitation may be employed. Furthermore, a DC motor may be used in place of the stepper motor. When a DC motor is used, an error counter, a D/A converter, and a servo amplifier are connected to the body PCB 110 in this order, and the servo amplifier is connected to the DC motor. The rotational position of the DC motor is detected by a rotary encoder, and a current rotational position of the DC motor is supplied as data from the rotary encoder to the error counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumference surfaces of the reels 101, 102, 103, 104, and 105 are able to individually illuminate 20 symbols having stopped on the display windows 150 by means of the backlight control circuit 153.

### Functions of Game Program

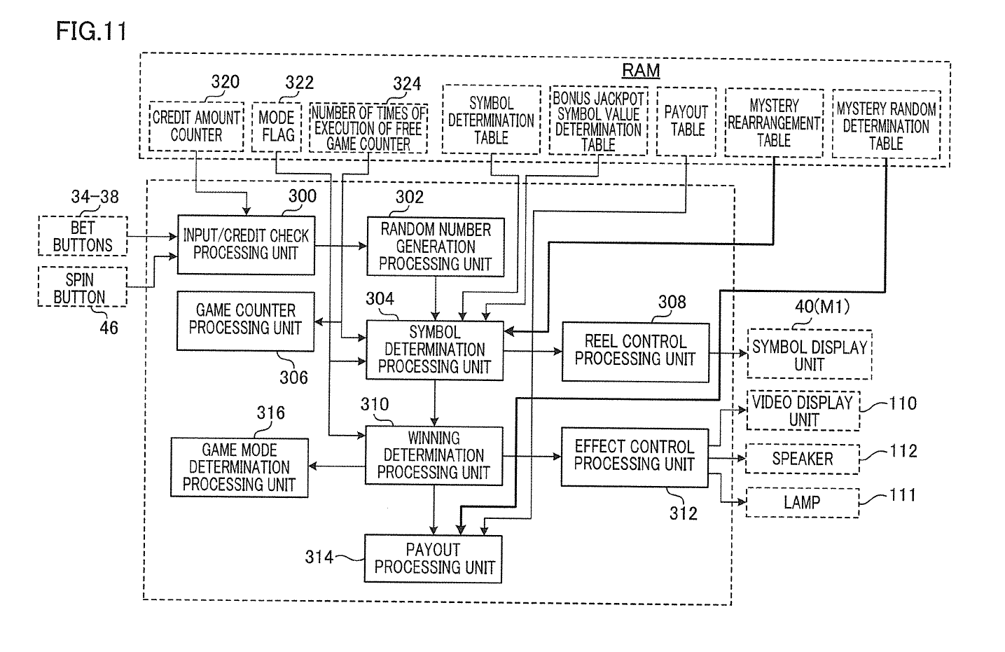

FIG. 11 is a functional block diagram showing the functions of the game program executed by the main CPU 71. First, when the gaming machine 10 is powered on, the main CPU 71 reads an authenticated game program and a game system program from a memory card 54 via a gaming board 50, and then write them in the RAM 73. In this way, the game program is executed after being downloaded to the RAM 73.

In a preferred embodiment, the game program includes an input/credit check processing unit 300, a random number generation processing unit 302, a symbol determination processing unit 304, a game counter processing unit 306, a reel control processing unit 308, a winning determination processing unit 310, an effect control processing unit 312, a payout processing unit 314, and a game mode determination processing unit 316.

The input/credit check processing unit 300 continuously check whether one of the BET switches 34S to 38S and the spin button 46 is pressed, in the idle state in which the reels 101 to 105 are not moving. When one of the BET switches 34S to 38S and the spin button 46, the input/credit check processing unit 300 checks if the player's credit remains, based on the credit amount counter 320 in the RAM 73. When at least one credit of the player remains, the input/credit check processing unit 300 calls the random number generation processing unit 302.

Thereafter, the random number generation processing unit 302 generates random numbers, and the symbol determination processing unit 304 uses the random numbers. In the present embodiment, the random number generation processing unit 302 generated five random numbers. The five random numbers are used for the first to fifth reels 101 to 105, respectively. Furthermore, a random number for determining the value of the BONUS symbol is generated. Furthermore, a random number for determining a winning based on the mystery random determination and a random number for determining the rearrangement state of the JACKPOT in the mystery random determination are generated.

After all of the five random numbers are sampled, the symbol determination processing unit 304 determines the to-be-stopped symbols on the reels 101 to 105 with reference to a symbol determination table stored in the RAM 73. The symbol determination processing unit 304 determines five to-be-stopped symbols on scroll lines (e.g., five reels 101 to 105) by using the five random numbers, and causes the symbols associated with the scroll lines (e.g., five reels 101 to 105) to appear in the display window 150 of the symbol display unit 40. After the random numbers for determining the values of BONUS and JACKPOT are sampled, the symbol determination processing unit 304 determines the values of the BONUS and JACKPOT with reference to a bonus jackpot symbol value determination table stored in the RAM 73. Furthermore, after the random number for determining the rearrangement state of the JACKPOT, the symbol determination processing unit 304 determines the rearrangement state of the JACKPOT with reference to a mystery rearrangement state table stored in the RAM 73.

The reel control processing unit 308 controls the reel unit M1 by supplying stop position information corresponding to the determined symbols. With this, the reels 101 to 105 rotate and then stop at the positions specified by the stop position information. That is to say, the symbols scroll in accordance with the rotation of the reels 101 to 105. Then the reels 101 to 105 stop so that the determined symbols are rearranged at the center in the vertical direction of the display window 150 of the symbol display unit 40.

The winning determination processing unit 310 determines whether a predetermined winning combination is formed by the rearranged symbols. When the winning combination is established by the rearranged symbols, the effect control processing unit 312 controls the symbol display unit 40 and other devices based on the winning combination and the game mode. The other devices include a speaker 112, a lamp 111, and a video display unit 110. The effects include an effect utilizing video and audio and an effect utilizing a change in the backlight and illumination. The payout processing unit 314 determines a payout amount based on the established winning combination and provides the payout amount to the player. That is to say, in the base game (normal game, chance game), the payout amount is awarded to the player based on the payout table, whereas, in the mystery random determination (second random determination), the payout amount is awarded to the player based on the mystery random determination table.

Each time the unit game ends, the game mode determination processing unit 316 determines the game mode in the next execution of the unit game. When the rearranged symbols form the free game trigger, the game mode determination processing unit 316 performs the shifting from the normal mode to the free game mode. When a condition of ending the free game is satisfied, the game mode determination processing unit 316 performs the shifting from the free game mode to the normal mode. In cases other than this, the game mode determination processing unit 316 maintains the current game mode. The game mode determination processing unit 316 may be executed in the winning determination processing unit 310.

The game counter processing unit 306 sets the number of times of execution of the free game in accordance with the winning combination determined by the winning determination processing unit 310, and subtracts 1 from the number of times of execution of free game counter 324 each time the free game is executed. When the predetermined winning combination is established in the free game mode, the number of times associated with that winning combination is added to the number of times of execution of free game counter 324 which stores the remaining number of times of execution of the free game. In the present embodiment, 1 is added to the counter when one bonus symbol is rearranged. The value of the number of times of execution of free game counter 324 is stored in the RAM 73. The game counter processing unit 306 may be arranged to belong to the symbol determination processing unit 304.

The input/credit check processing unit 300 may be an independent input/credit check processing device 300′. The random number generation processing unit 302 may be an independent random number generation processing device 302′. The symbol determination processing unit 304 may be an independent symbol determination processing device 304′. The game counter processing unit 306 may be an independent game counter processing unit device 306′. The reel control processing unit 308 may be an independent reel control processing device 308′. The winning determination processing unit 310 may be an independent winning determination processing device 310′. The effect control processing unit 312 may be an independent effect control processing device 312′. The payout processing unit 314 may be an independent payout processing device 314′. The game mode determination processing unit 316 may be an independent game mode determination processing device 316′. As such, a group of the independent devices may be employed. Some of the devices above may be combined. In any case, a process, a part, a device, or a unit which is capable of executing the game program is employed.

### Paylines

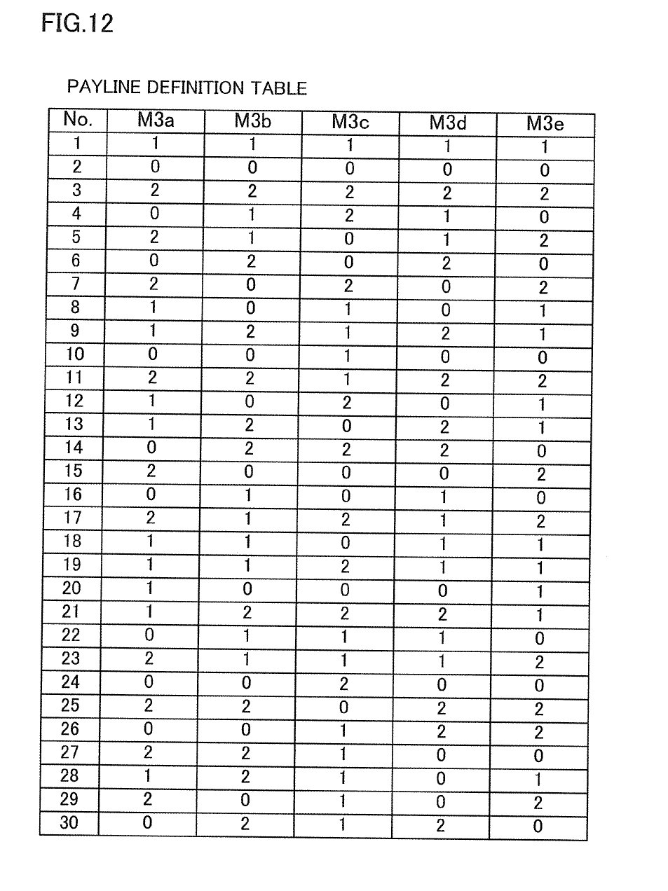

FIG. 12 shows an example of the payline definition table which defines the paylines in the gaming machine 10. In the gaming machine 10, 30 paylines are set in the symbol matrix. The payline definition table defines, in the display window 150, paylines formed by connecting the upper stages, the central stages, or the lower stages of the first to fifth reels 101 to 105.

For example, one payline (a payline with (No.=1)) is constituted by the central stage of the first reel 101 (first column), the central stage of the second reel M3b (second column), the central stage of the third reel 103 (third column), the central stage of the fourth reel M3d (fourth column), and the central stage of the fifth reel M3e (fifth column).

In the slot machine 10 of the present embodiment, all of 30 paylines are active irrespective of the bet amount and the selection by the player. Alternatively, a payline may be activated by the player's selection. The total number of the paylines is suitably determined in accordance with the size of the symbol matrix.

### Symbol Determination Table

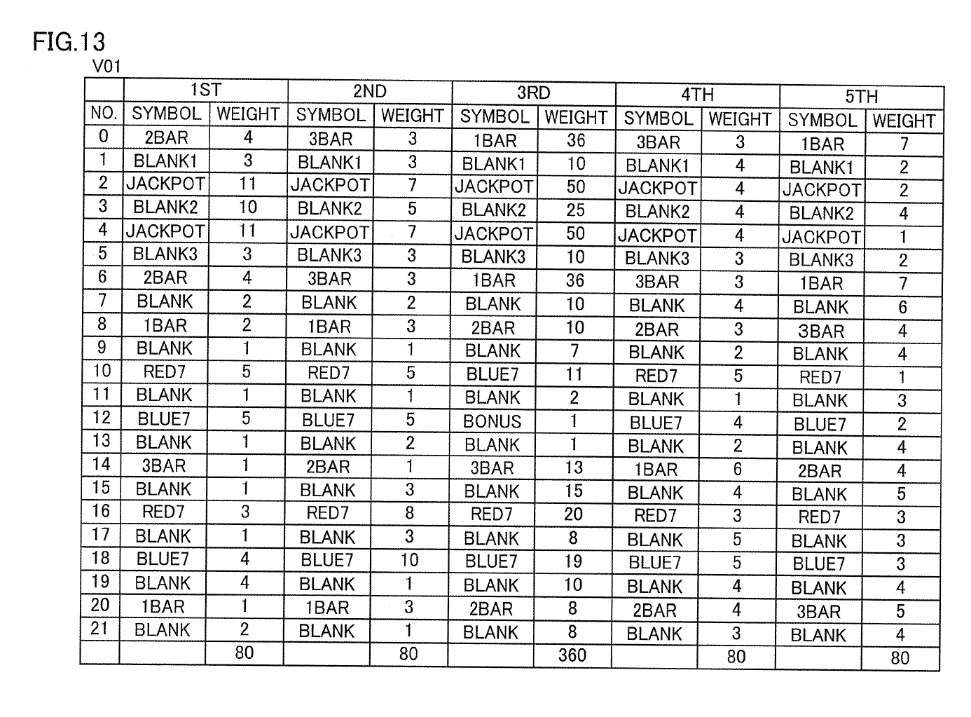

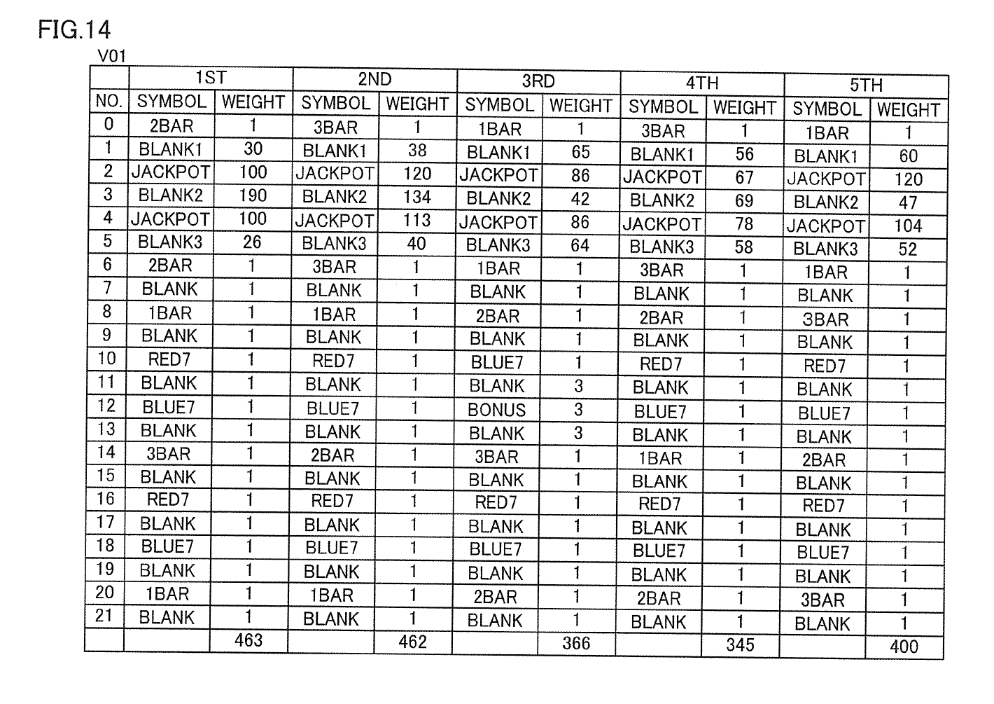

FIG. 13 and FIG. 14 show examples of the symbol determination table. FIG. 13 shows the weights in the normal game mode whereas FIG. 14 shows the weights in the free game mode.

The symbol determination table defines the symbols provided on the reels 101 to 105 and the weights (appearance probabilities) of these symbols. The symbol determination table defines at which probability each of the symbols on the reels 101 to 105 appears at the central stage of the symbol matrix (the central stage of the display window 150).

This symbol determination table defines the appearance probability of each symbol. For example, the weight of the 2BAR with the code number NO. 0 on the first reel 101 shown in FIG. 14 is “4”, and the appearance probability thereof is 4/80 (80 in the lowest row indicates the total weight. This number is shown for convenience, and may not be included in the symbol determination table).

In a later-described symbol random determination process, five random numbers are sampled, and five symbols corresponding to the respective reels 101 to 105 are determined based on the sampled random numbers and with reference to the symbol determination table shown in FIG. 13 or FIG. 14. The reels 101 to 105 are stopped so that the determined five symbols are arranged at the central stage of the symbol matrix.

As shown in FIG. 13 and FIG. 14, the weights in the free game mode are arranged so that JACKPOT at NO. 2, BLANK at NO. 3, and JACKPOT at NO. 4 are easily won as compared to the weights in the normal game mode. In the unit game in the free game mode, JACKPOT at NO. 2, BLANK at NO. 3, and JACKPOT at NO. 4 are more likely to stop at the central stage of the symbol matrix.

BONUS is only at NO. 12 of the reel 103. As described above, when BONUS appears in the upper stage, the central stage, or the lower stage of the display window 150, the trigger of the free game is established. That is to say, in the symbol random determination process, the trigger of the free game is established when NO. 11, NO. 12, or NO. 13 of the reel 103 is achieved.

JACKPOT are provided at NO. 2 and NO. 4 of each of the five reels 101 to 105. JACKPOT is also a scatter symbol, and ten JACKPOT symbols may appear in the display window 150 at the maximum.

### Payout Table

FIG. 15 and FIG. 16 show examples of the payout table defining nine types of winning patterns.

The payout table shows the relationship between the winning patterns, the number of kinds of the symbols, and the payouts. The number of kinds indicates the number of the symbols constituting a winning pattern, i.e., the number of the symbols successively lined up along a payline from left to right. As described above, in the gaming machine 10 of the present embodiment, whether a winning is achieved is determined from left to right, except when JACKPOT and BONUS which are scatter symbols are involved. On this account, a payout is determined based on the type and the number of the symbols successively lined up along a payline from the leftmost reel 101 toward the rightmost reel M3e.

The first winning pattern is arranged such that three, four, or five RED7 symbols are successively lined up on a payline. The second winning pattern is arranged such that three, four, or five BLUE7 symbols are successively lined up on a payline.

For example, in the first winning pattern, when RED7, RED7, and RED7 are successively lined up along a payline from the leftmost reel 101, the number of kinds is three and the payout is 50. Similarly, when RED7, RED7, RED7, and RED7 are successively lined up along a payline from the leftmost reel 101, the number of kinds is four and the payout is 100. When RED7, RED7, RED7, RED7, and RED7 are successively lined up along a payline from the leftmost reel 101, the number of kinds is five and the payout is 500.

The third winning pattern relates to ANY7. ANY7 indicates a pattern in which two types of symbols of RED7 and BLUE7 are mixedly lined up on a payline or a pattern in which two types of symbols of BLUE7 and RED7 are mixedly lined up along a payline. The third winning pattern indicates that three, four, or five symbols satisfying the pattern of ANY7 are successively lined up along a payline.

The fourth winning pattern indicates a pattern in which three, four, or five 3BAR are successively lined up along a payline. The fifth winning pattern indicates a pattern in which three, four, or five 2BAR are successively lined up along a payline. The sixth winning pattern indicates a pattern in which three, four, or five 1BAR are successively lined up along a payline.

The seventh winning pattern relates to ANYBAR. ANYBAR indicates a pattern in which three types of symbols of 3BAR, 2BAR, and 1BAR are mixedly lined up on a payline and a pattern in which three types of symbols of 2BAR, 3BAR, and 1BAR are mixedly lined up on a payline. The seventh winning pattern is a pattern in which three, four, or five symbols satisfying the pattern of ANYBAR are successively lined up on a payline.

The eighth winning pattern relates to BONUS. The ninth winning pattern relates to JACKPOT. BONUS and JACKPOT are scatter symbols. On this account, a payout is determined based solely on the number of the symbols appearing in the display window 150, irrespective of the paylines.

As described above, BONUS is provided only at NO.12 of the reel M103. The payout when the one BONUS appears is 30. In the eighth winning pattern, the payout is 30 when the BONUS on the reel M103 appears in the upper stage, the central stage, or the lower stage in the display window 150.

JACKPOT is a scatter symbol, too. The payout when four JACKPOT appear in the display window 150 is 40. The payout when five JACKPOT appear in the display window 150 is 100. The payout when six JACKPOT appear in the display window 150 is 500. The payout when seven JACKPOT appear in the display window 150 is 1500. The payout when eight JACKPOT appear in the display window 150 is 3000. The payout when nine JACKPOT appear in the display window 150 is 10000. The payout when all of ten JACKPOT appear in the display window 150 is 25000. The ninth winning pattern relates to these JACKPOT.

As described above, when four or more JACKPOT appear, the payout is determined in accordance with the number of appearing JACKPOT, as a normal payout (fixed payout). Furthermore, in the gaming machine 10 of the present embodiment, as a progressive function, the progressive is won in addition to the fixed payout above when six or more JACKPOT are rearranged in the display window 150, and the progressive value having been accumulated up to that time is awarded as a jackpot payout.

In the gaming machine 10, each time the unit game is executed, the winning determination processing unit 310 shown in FIG. 11 determines whether a winning pattern defined in the payout table is established, with reference to the payout table. When a winning pattern defined in the payout table is established, the winning determination processing unit 310 reads a payout corresponding to the number of kinds, with reference to the payout table. Furthermore, the winning determination processing unit 310 determines whether a winning pattern is satisfied for BONUS and JACKPOT, too, and reads a payout corresponding to the number of kinds.

The payout processing unit 314 awards a payout amount corresponding to the payout having been read. In the meanwhile, when no winning pattern is satisfied, the winning determination processing unit 310 determines that the result is a miss. The benefit as a result of the payout is awarded to the player in the form of, for example, addition of a credit corresponding to the payout amount.

### Mystery Random Determination Table

FIG. 17 shows an example of the mystery random determination table which is referred to in the mystery random determination. The mystery random determination table defines progressive ranks of the linked progressive jackpot (the numbers of kinds of the jackpot symbols) and the random determination probabilities based on weights in association with the progressive ranks. To be more specific, five progressive ranks 1st, 2nd, 3rd, 4th, and 5th and no progressive rank are set, and the random determination probabilities are set by associating weights with the respective progressive ranks. With this, in the mystery random determination, a miss with which no progressive rank occurs happens at the probability of 95.01%, and the linked progressive jackpot corresponding to one of the progressive ranks 1st, 2nd, 3rd, 4th, and 5th happens at the remaining probability of 4.99%.

### Jackpot Symbol Rearrangement State Table

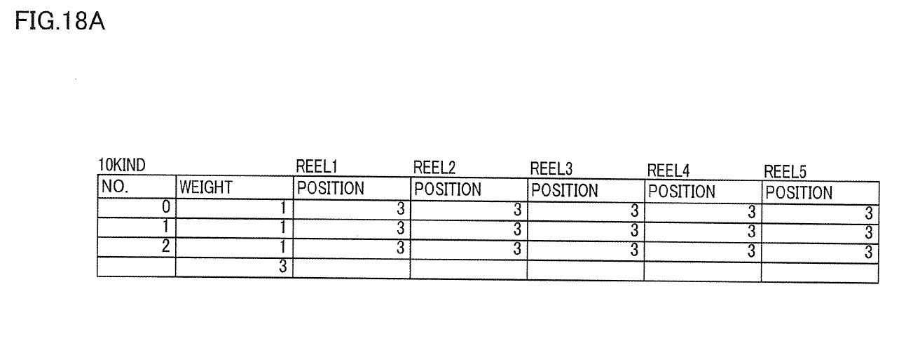

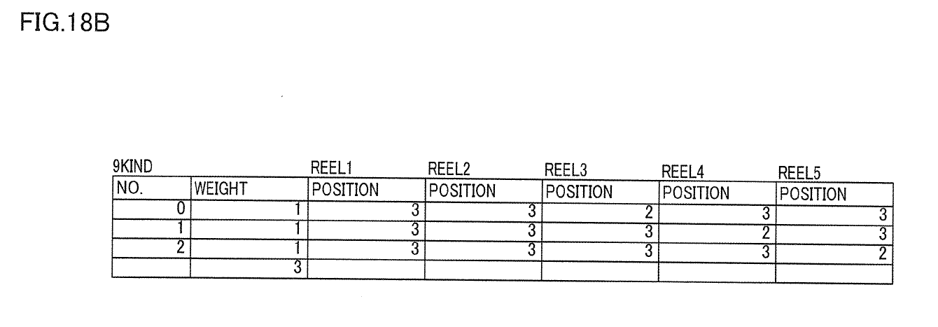

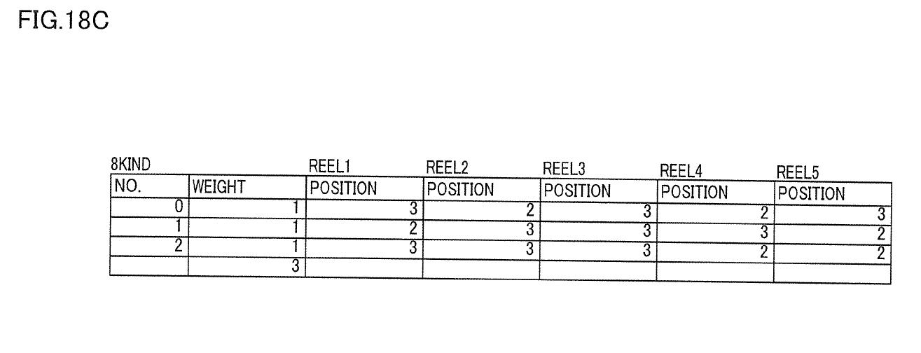

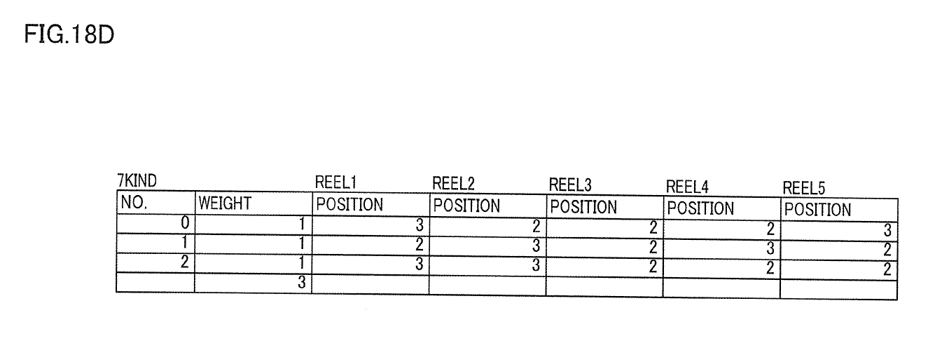

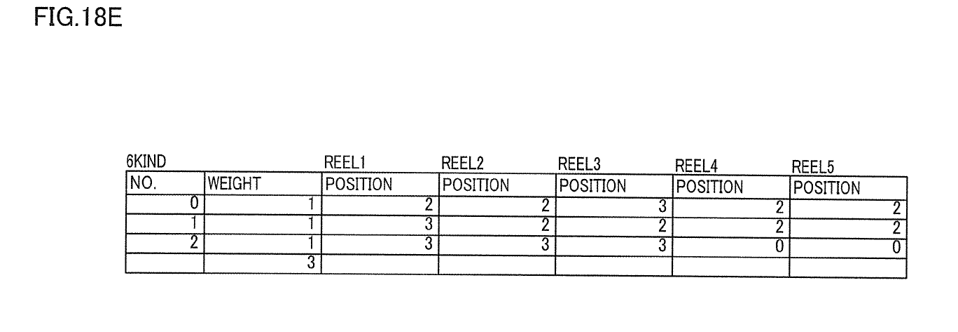

FIG. 18A to FIG. 18E show examples of the jackpot symbol rearrangement state table when the linked progressive jackpot is won in the mystery random determination. FIG. 18A is a table selected when the progressive rank is 1st. In this table, 10-Kind jackpot symbols may be rearranged in one of three types of rearrangement states 0 to 2. To be more specific, weights 1, 1, and 1 are set for the respective rearrangement states 0, 1, and 2, and the probability of the appearance of each symbol of the reels 101 to 105 on the central stage of the symbol matrix (i.e., the central stage of the display window 150) is defined.

FIG. 18B is a table selected when the progressive rank is 2nd. In this table, 9-Kind jackpot symbols may be rearranged in one of three types of rearrangement states 0 to 2. To be more specific, weights 1, 1, and 1 are set for the respective rearrangement states 0, 1, and 2, and the probability of the appearance of each symbol of the reels 101 to 105 on the central stage of the symbol matrix (i.e., the central stage of the display window 150) is defined.

FIG. 18C is a table selected when the progressive rank is 3rd. In this table, 8-Kind jackpot symbols may be rearranged in one of three types of rearrangement states 0 to 2. To be more specific, weights 1, 1, and 1 are set for the respective rearrangement states 0, 1, and 2, and the probability of the appearance of each symbol of the reels 101 to 105 on the central stage of the symbol matrix (i.e., the central stage of the display window 150) is defined.

FIG. 18D is a table selected when the progressive rank is 4th. In this table, 7-Kind jackpot symbols may be rearranged in one of three types of rearrangement states 0 to 2. To be more specific, weights 1, 1, and 1 are set for the respective rearrangement states 0, 1, and 2, and the probability of the appearance of each symbol of the reels 101 to 105 on the central stage of the symbol matrix (i.e., the central stage of the display window 150) is defined.

FIG. 18E is a table selected when the progressive rank is 5th. In this table, 6-Kind jackpot symbols may be rearranged in one of three types of rearrangement states 0 to 2. To be more specific, weights 1, 1, and 1 are set for the respective rearrangement states 0, 1, and 2, and the probability of the appearance of each symbol of the reels 101 to 105 on the central stage of the symbol matrix (i.e., the central stage of the display window 150) is defined.

As such, when the linked progressive jackpot with the progressive rank 1st, 2nd, 3rd, 4th, or 5th is won in the mystery random determination, the jackpot symbol rearrangement state table corresponding to that progressive rank 1st, 2nd, 3rd, 4th, or 5th is referred to and the rearrangement state of the jackpot symbol is determined based on the random determination using the weight. The predetermined number of kinds of the jackpot symbols are rearranged on the reels 101 to 105 with the determined rearrangement state.

In this way, the gaming machine 10 includes the rearrangement state table defining rearrangement states of the jackpot symbols for the respective types of the linked progressive jackpot, and is arranged such that, in the mystery random determination, when the linked progressive jackpot is established, the rearrangement state corresponding to that type of the linked progressive jackpot is randomly selected from the plural rearrangement states. With this, even if the linked progressive jackpot of the same type (same progressive rank) is established, the jackpot symbols are rearranged based on the rearrangement state which is randomly selected from the plural rearrangement states. In this way, the rearrangement state is sophisticated.

### State Shifting in Games

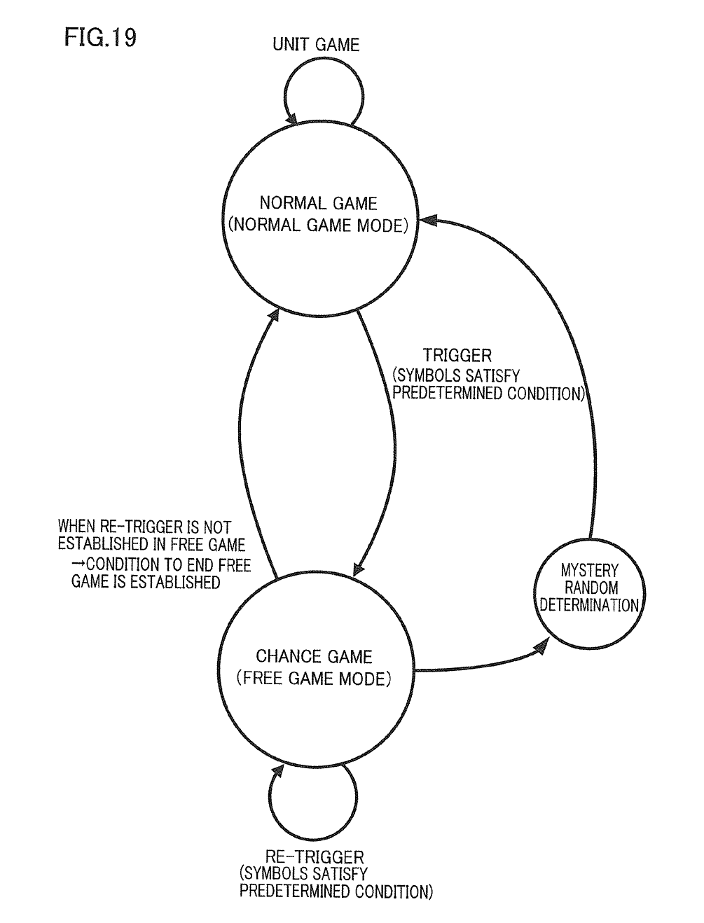

FIG. 19 shows the state shifting in the gaming machine 10. To be more specific, the figure shows the shifting between the normal game mode, the free game mode, and the mystery random determination. The normal game mode is a state in the normal game, whereas the free game mode is a game state in the chance game.

The gaming machine 10 has two types of game modes, i.e., the normal game mode and the free game mode. In the gaming machine 10, the unit game is executed in the normal game mode which is a main mode, and the normal game mode is shifted to the free game mode when a trigger (event) of the free game occurs in the normal game mode. As described above, the probabilities of the awarding of the linked progressive jackpot which is equivalent to the special payout in the normal game mode and the free game mode are controlled by the control unit so that the probability is higher in the free game than in the normal game.

In the present embodiment, the free game is triggered when the BONUS symbol appears in the display window 150 of the symbol display unit 40. As a matter of course, the free game may be differently triggered.

As shown in FIG. 19, in the normal game mode, the unit game is repeatedly executed until the BONUS appears in the display window 150 of the symbol display unit 40. In this normal game mode, when one of the winning patterns shown in FIG. 15 and FIG. 16 is established, the payout amount of the payout corresponding to the winning pattern is awarded.

When the free game trigger occurs in the normal game mode, the normal game mode is shifted to the free game mode. The free game mode in the gaming machine 10 of the present embodiment is a game mode in which the unit game is executed once. Basically, the free game mode is shifted to the normal game mode after the unit game is executed once.

In the free game mode, the unit game similar to that in the normal game mode is executed without consuming a game medium such as a medal. As shown in FIG. 15, in the free game mode, JACKPOT at NO. 2, BLANK at NO. 3, and JACKPOT at NO. 4 are more likely to be rearranged on the five reels 101 to 105.

In the free game mode, when the re-trigger occurs, one execution of the unit game in the free game mode is added. On this account, the free game mode is maintained only when the re-trigger occurs. When no re-trigger occurs, the free game mode is shifted to the normal game mode after the mystery random determination is always executed. In the present embodiment, at the end of the free game mode which is the chance game, the mystery random determination is always executed. Alternatively, the random determination may be randomly conducted. However, an object of the present invention is to connect, by using a connection unit, gaming machines which are different from one another in the winning probability of a special payout in the symbol random determination so as to arrange the winning probability of the special payout which is a common prize to be identical between the gaming machines by means of the second random determination which is different from the symbol random determination, by a simple program structure. On this account, the arrangement in which the random determination is always executed is preferable in consideration of the design of the probabilities.

As described above, in the present embodiment, the number of times of execution of the unit game in the free game mode is only one at the time of the shifting from the normal game mode to the free game mode, and this is not changed based on a result of the unit game in the normal game mode or the like. One execution of the unit game is added only when the re-trigger occurs after the actual shifting to the free game mode. After the shifting to the free game mode, whether the execution of the unit game is added is determined.

### Contents of Program

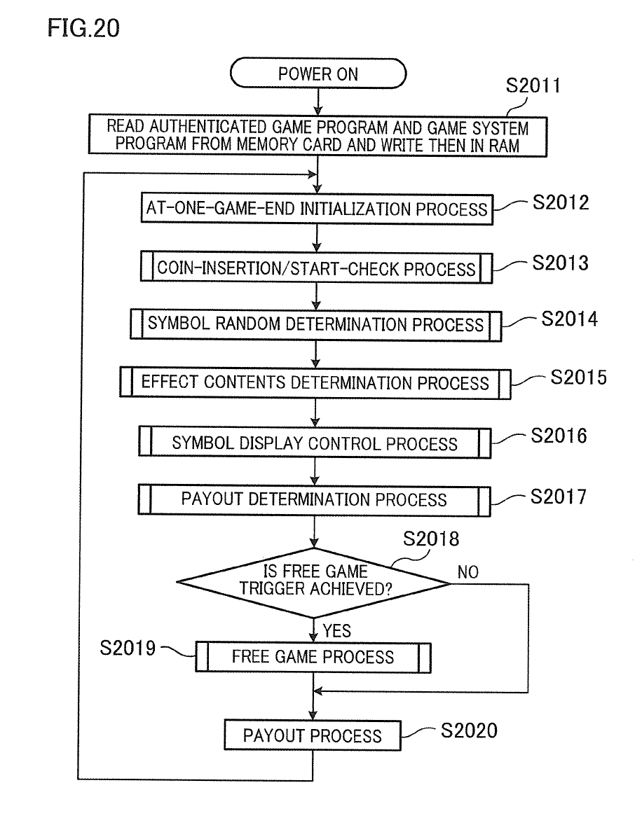

Now, the program to be executed by the gaming machine 10 is described with reference to FIGS. 20 to 28.

### Main Control Process

Referring to FIG. 20, a main control process will be described. FIG. 20 is a flowchart of the main control process of the gaming machine 10 of the embodiment of the present invention. The game mode in the main control process shown in FIG. 20 is the normal game mode.

To begin with, when the gaming machine 10 is powered on, the main CPU 222 reads a game program and game system program which have been authenticated from the memory card 210 via a game board 200, and writes the programs into the RAM 226 (S2011).

Next, the main CPU 222 executes an at-one-game-end initialization process (S2012). This process clears data in a working area of the RAM 226, which becomes unnecessary at the end of each round of game, e.g., the amount of bet, symbols randomly determined, and the like.

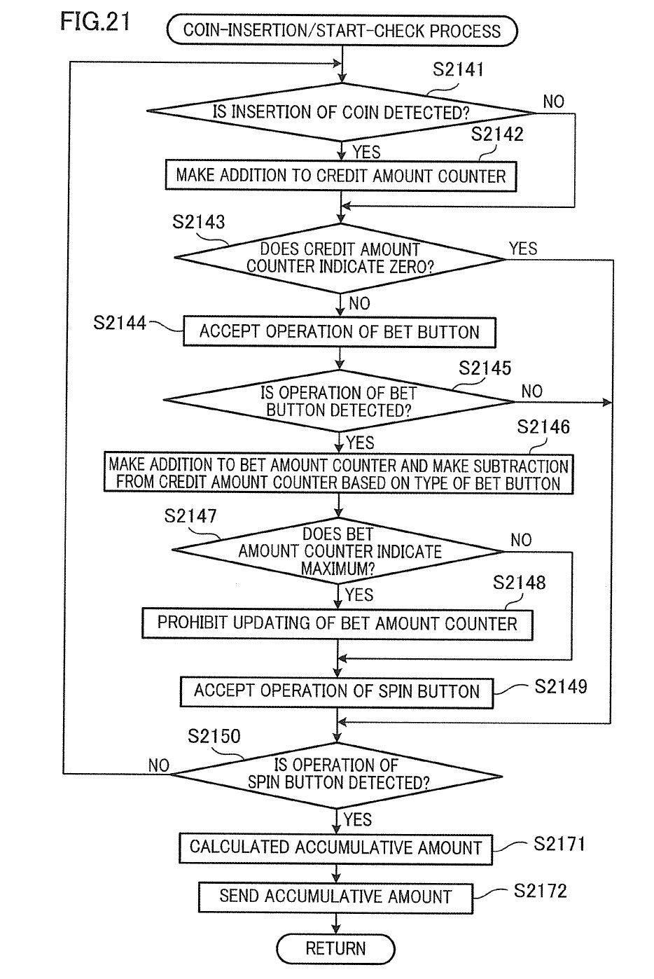

Next, the main CPU 222 executes a coin input/start check process which is described later with reference to FIG. 21 (S2013). An input to the BET buttons and the spin button is checked in this process, for example.

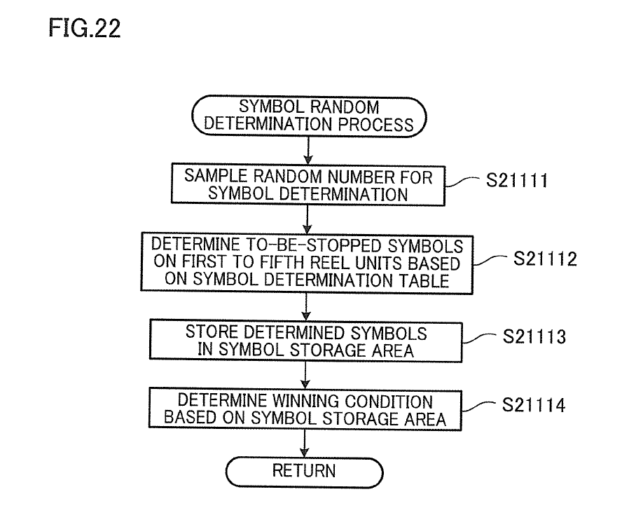

Subsequently, the main CPU 222 executes a symbol random determination process which will be described later with reference to FIG. 22 (S2014). In this process, to-be-stopped symbols are determined based on symbol determination random numbers, and a value of the BONUS symbol is further determined when the free game trigger has been established.

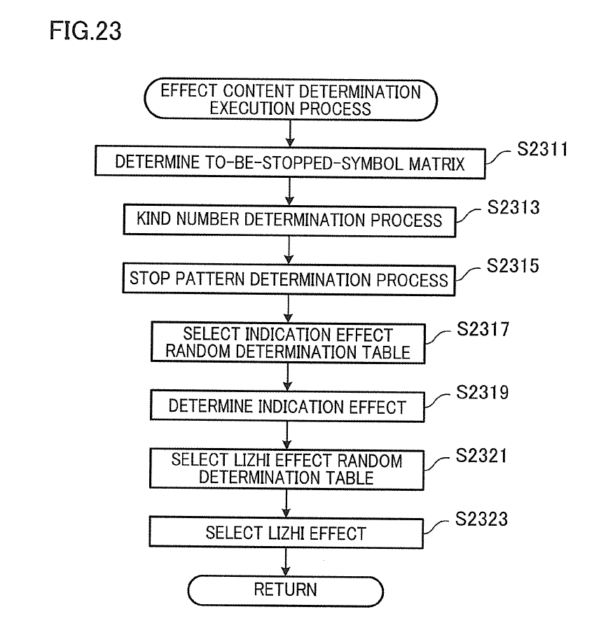

Subsequently, the effect control processing unit 312 executed by the main CPU 222 executes an effect content determination execution process which will be described with reference to FIG. 23 (S2015). The main CPU 222 samples an effect-use random number and randomly determines any of a plurality of predetermined contents of effect, and executes the effect contents at the determined timing. For example, an image for the effect is displayed on the video display unit 110, sound is output from the speaker 112, the lamp 114 is turned on, and an effect process is performed therefor. When, for example, the free game trigger is established or the player selects the free game thereafter, a further effect process is executed so that an image is displayed on the video display unit 110. This will be detailed later.

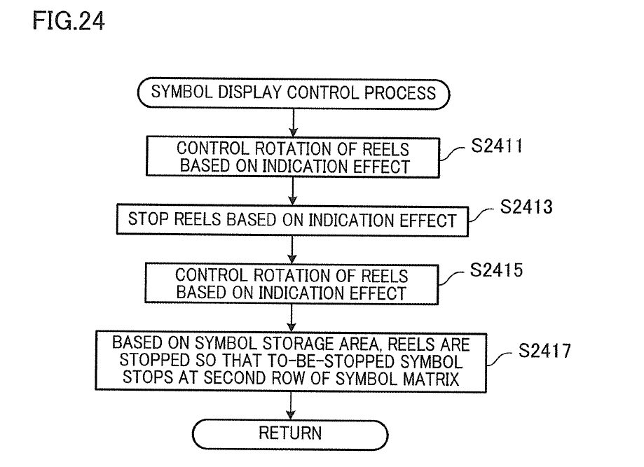

Subsequently, the main CPU 222 executes a symbol display control process which will be described later with reference to FIG. 24 (S2016). In this process, scrolling of the reels is started, and the to-be-stopped symbols, which are determined in the symbol random determination process of S2014, are stopped in predetermined positions. Furthermore, based on the value of the BONUS symbol determined in the symbol random determination process in the step S2014, illumination of each reel is carried out.

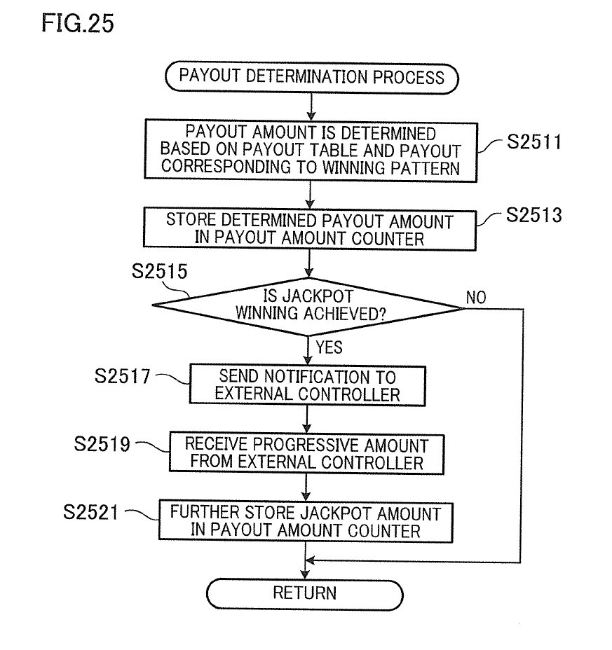

Thereafter, the main CPU 222 executes a payout determination process which will be described later with reference to FIG. 25 (S2017). In this process, in the normal game, a payout amount is determined in accordance with the combination of the symbols displayed on a payline and with reference to the payout table (see FIG. 15 and FIG. 16), and the payout amount is stored in the payout amount storage area in the RAM 226 (payout counter 321). When the free game trigger is established, in accordance with the combination of the BONUS symbols, the payout amount is determined based on a rule different from the rule in the normal game.

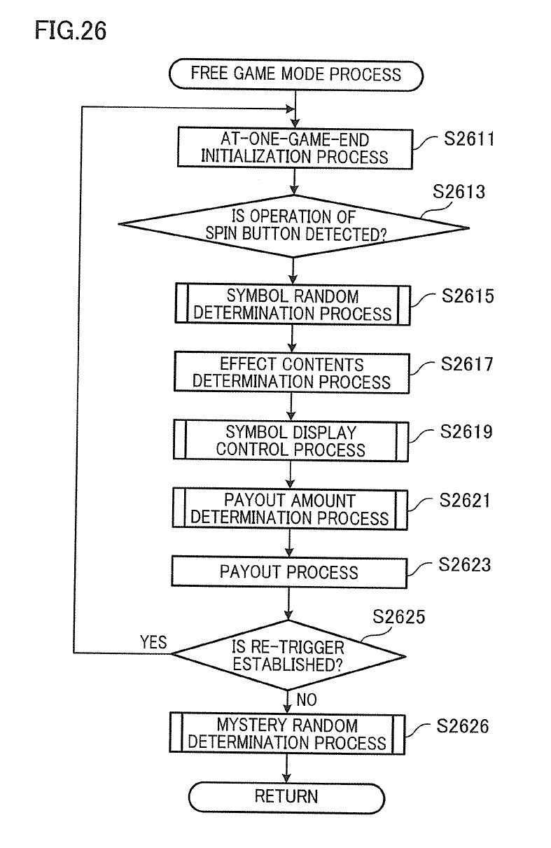

Next, the main CPU 222 determines whether or not a free game trigger has been established (S2018). When the free game trigger is established (e.g., it is determined that the free game trigger is established when the game mode is the free game mode), the main CPU 222 executes a free game mode process which will be described later with reference to FIG. 26 (S2019).

Next, after the step S2019 or when the main CPU 222 determines that the free game trigger is not established in the step S2018, the main CPU 222 executes a payout process (S2020). The main CPU 222 adds the value stored in the payout amount storage area (payout counter 321) to the value stored in the credit amount storage area in the RAM 226 (credit amount counter 320). Alternatively, the hopper 242 is controlled so that a coin corresponding to the payout counter 321 is discharged from the coin payout exit. Alternatively, the ticket printer 120 is controlled so that a ticket with a barcode, in which the payout counter 321 is recorded, is issued. After this process, the mode flag, the BONUS symbol value storage area, and the like are cleared and the process proceeds to the step S2012.

### Coin Input/Start Check Process

Next, the coin input/start check process is described reference to FIG. 21. FIG. 21 is a flowchart of a coin input/start check process of the gaming machine 10 of the embodiment of the present invention.

To begin with, by the input/credit check processing unit 300 executed by the main CPU 222, the main CPU 222 determines whether the coin counter 232 detects the insertion of a coin (S2141). The main CPU 222, when determining that an input of coin is detected, performs addition to the value stored in the credit amount storage area (credit amount counter 320) (S2142). In addition to the insertion of the coin, whether a bill is inserted may be determined by bill validation data 246, and when the bill is inserted, a value corresponding to the bill may be added to the credit amount counter 320.

After the step S2042 or when an input of coin is not detected in the step S2141, the main CPU 222 determines whether or not the credit amount counter 320 is 0 (S2143). When the credit amount counter 320 is not zero, the main CPU 222 allows the receiving of an operation of the BET buttons (S2144).

Next, the main CPU 222 determines whether or not an operation of the bet button is detected (S2145). When an operation of the bet button by a player is detected by the bet switch, the main CPU 222 performs addition to the value stored in a bet amount storage area provided to the RAM 226, and performs reduction from the value stored in the credit amount counter 320, based on the type of the bet button (S2146).

Subsequently, the main CPU 222 determines whether the bet amount counter 325 indicates the maximum value (S2147). When the bet amount counter 325 indicates the maximum value, the main CPU 222 prohibits the updating of the bet amount counter 325 (S2148). The main CPU 222, after the step S2148 or when determining that the bet amount counter 325 does not indicate the maximum value, enables operation of the spin button (S2149).

After the step S2149, when in the step S2145 an operation of the BET buttons is not detected or when in the step S2143 the credit amount counter 320 is zero, the main CPU 222 determines whether an operation of the spin button is detected (S2150). When the main CPU 222 determines that an operation of the spin button is not detected, the process moves to the step S2141.

When an operation of the spin button is detected, the main CPU 222 calculates an accumulative amount (S2571). The main CPU 71 multiplies the value stored in the bet amount storage area by an accumulative rate so as to find the accumulative amount to be added to the progressive value.

Subsequently, the main CPU 71 sends the calculated accumulative amount to the external controller 190 (S2572), and ends the coin input/start check process. Upon receiving the accumulative amount, the external controller 190 updates the progressive value.

### Symbol Random Determination Process

Now, the symbol random determination process will be described with reference to FIG. 22. FIG. 22 is a flowchart of the symbol random determination process of the gaming machine 10 of the embodiment of the present invention.

To begin with, the random number generation processing unit 302 which is executed by the main CPU 222 samples five random numbers for symbol determination (S2211). Subsequently, the symbol determination processing unit 304 executed by the main CPU 222 determines to-be-stopped symbols on the reels by random determination based on the five random numbers (S2212).

In the step S2212, when the game mode is the normal game mode, five to-be-stopped symbols are determined with reference to the symbol determination table for the normal game mode shown in FIG. 14. When the game mode is the free game mode, five to-be-stopped symbols are determined with reference to the symbol determination table for the free game mode shown in FIG. 15.

To put it differently, the main CPU 222 samples five random numbers for symbol determination, and for each of the five reels 101 to 105, selects one of the 22 symbols (with the code numbers “NO. 0” to “NO. 21”) as the to-be-stopped symbol, with reference to the symbol determination table shown in FIG. 14 or FIG. 15.

The appearance probabilities of the 22 symbols (with the code numbers “NO. 0” to “NO. 21”) are determined based on the weights in the symbol determination table shown in FIG. 14 or FIG. 15. As such, based on whether the game mode is the normal game mode or the free game mode, the appearance probabilities of the 22 symbols (with the code numbers “NO. 0” to “NO. 21”) are differentiated.

In the step S2212, five to-be-stopped symbols corresponding to the five reels 101 to 105 are determined. Each of the five reels 101 to 105 is stopped so that the determined five to-be-stopped symbols stop in the central stage of the symbol matrix (the central stage of the display window 150).

Subsequently, the main CPU 222 stores the determined to-be-stopped symbols of the reels in the symbol storage area of the RAM 226 (S2213). Then the winning determination processing unit 310 which is executed by the main CPU 222 determines a winning pattern based on the symbols stored in the symbol storage area and with reference to the payout tables shown in FIG. 15 and FIG. 16 (S2214). When a winning pattern is satisfied, the main CPU 222 determines the payout corresponding to the number of kinds.

### Effect Content Determination Execution Process

Now, the effect content determination execution process will be described with reference to FIG. 23. FIG. 23 is a flowchart of the effect content determination execution process in the gaming machine 10 of the embodiment of the present invention.

In this process, the operations of the five reels 101 to 105 from the start to the stop of the rotation are defined. The process is for determining an effect produced by the operation of the five reels 101 to 105. On this account, this effect content determination execution process is executed based on the result of the symbol random determination process in the step S2014 shown in FIG. 20.

To be more specific, to begin with, five to-be-stopped symbols corresponding to the respective five reels 101 to 105 are determined in the symbol random determination process in the step S2014 shown in FIG. 20. Subsequently, by using the determined five to-be-stopped symbols, a symbol matrix constituted by the to-be-stopped symbols to be rearranged in the display window 150 is determined with reference to the symbol determination table shown in FIG. 14 or FIG. 15. In other words, all of 15 to-be-stopped symbols (to-be-stopped symbol matrix) to be rearranged in the display window 150 are determined based on the five to-be-stopped symbols.

The symbol matrix which is constituted by the rearranged symbols in the display window 150 when all of the five reels 101 to 105 actually stop will be simply referred to as a symbol matrix or will be referred to as an after-stop symbol matrix.

In the present embodiment, because the same symbols are rearranged on the five reels 101 to 105 both in the normal game mode and in the free game mode, the to-be-stopped symbol matrix is determined with reference to the symbol determination table shown in FIG. 14 or FIG. 15, irrespective of the game mode.

As the to-be-stopped symbol matrix is determined, the number of JACKPOT in the to-be-stopped symbol matrix and the arrangement pattern of the JACKPOT are obtained.

To begin with, by using the five to-be-stopped symbols determined in the symbol random determination process in the step S2014 shown in FIG. 20, the main CPU 222 determines the to-be-stopped symbol matrix (S2311). The determined to-be-stopped symbol matrix is stored in the RAM 226. To be more specific, the code numbers of the 15 to-be-stopped symbols constituting the to-be-stopped symbol matrix are stored in the RAM 226.

Subsequently, the main CPU 222 obtains, as the number of kinds, the number of JACKPOT included in the to-be-stopped symbol matrix (S2313). Because the JACKPOT is a scatter symbol, the number of JACKPOT to appear in the display window 150 is obtained from the to-be-stopped symbol matrix.

Subsequently, the main CPU 222 obtains, as a stop pattern, the arrangement pattern of the JACKPOT which will appear and form the to-be-stopped symbol matrix (S2315).

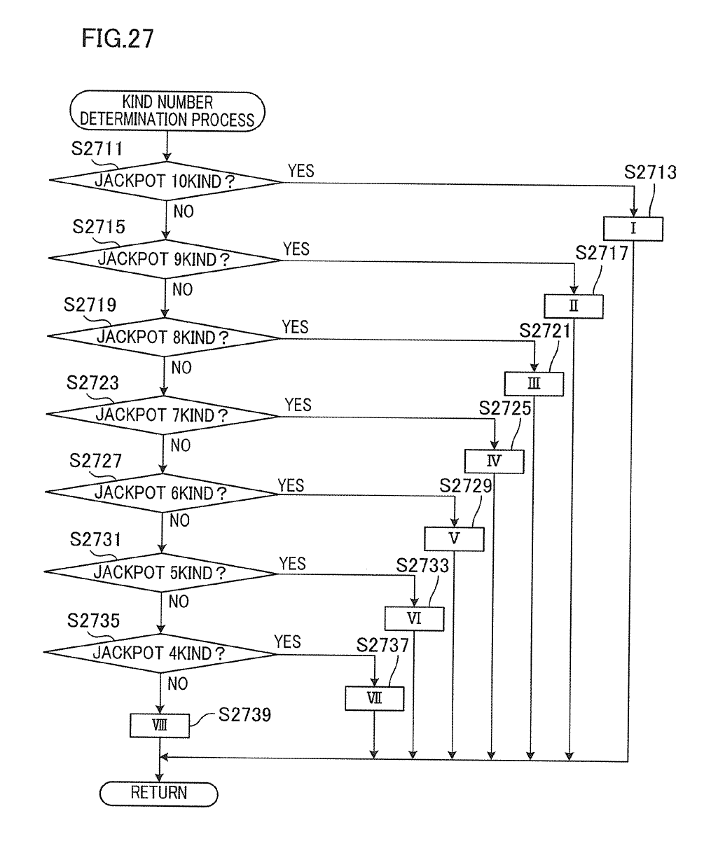

Subsequently, the main CPU 222 calls and executes the Kind number determination process shown in FIG. 27 and determines the indication effect table (S2317). This process is a process for determining the indication effect table based on the number of kinds obtained in the step S2313.

Subsequently, the main CPU 222 determines an indication effect with reference to the indication effect table selected in the step S2317 (S2319). The indication effect is an operation of the five reels 101 to 105 from the start of the rotation of the five reels 101 to 105 to an intermediate state in which at least one of the reels stops whereas the remaining reels re still rotating.

The indication effect table defines weights for plural types of indication effects, respectively. The step S2319 is a process in which random numbers are generated and one of the types of the indication effects is selected by using the generated random numbers with reference to the indication effect table. With this, different types of indication effects are executed even if the number of kinds is the same, and hence various indication effects are executed.

In addition to the above, the indication effect table is provided for each of the normal game mode and the free game mode. A different indication effect is therefore executed in each game mode.

As such, the indication effect from the start of the rotation of the reels to the intermediate state is determined based on the number of JACKPOT in the to-be-stopped symbol matrix and the arrangement pattern. When the indication effect is determined, the direction of the rotation, the speed of the rotation, the time of the rotation, and other aspects of the rotation of the five reels 101 to 105 are determined.

For each indication effect, a motor control parameter for controlling a motor to drive the five reels 101 to 105 is set in advance and stored in the RAM 226. When the indication effect is determined, the corresponding motor control parameter is read and the motor is controlled, and hence the effect is executed by the five reels 101 to 105.

Subsequently, the main CPU 222 reads and executes a stop pattern determination process and determines the lizhi effect table (S2321). This process is a process for determining the lizhi effect table based on the stop pattern obtained in the step S2315.

The lizhi typically indicates a state in which at least one of the reels stops whereas the remaining reels are rotating, the stopped reels form a part of the winning pattern, and whether the winning pattern is ultimately formed depends on a symbol which appears after the stop of the rotating reels. In other words, the lizhi is an incomplete state in which a part of a winning pattern is formed, and is a state immediately before the final determination of whether the winning pattern is formed.

Alternatively, the lizhi in the present embodiment may be a state in which the final payout has not been determined, instead of the state in which a winning pattern is not completely formed. To be more specific, at least one of the reels stops whereas the remaining reel is rotating, the stopped reels form a part of the winning pattern with which a payout is awarded, and whether the payout is ultimately awarded is determined depending on the symbol which appears when the rotating reel stops.

As such, the lizhi may be a state in which a payout is awarded or a state in which no payout is awarded. While in the lizhi of the known arrangements whether a payout is awarded is indefinite, in the lizhi of the present embodiment it has been confirmed that at least a part of the payout is awarded. Even when a payout is awarded in the lizhi, the final payout has not been determined. The final payout is determined when all of the reels stop.

For example, when a payout is determined in accordance with the number of scatter symbols, five scatter symbols appear in the lizhi and a payout for the five symbols is determined. When the final state is established as all of the reels stop and the number of the scatter symbols increases by three with the result that eight scatter symbols appear, a payout for the eight symbols is determined. In the meanwhile, when the number of the symbols remains five at the stop of the all reels, a payout for the five symbols is determined. As such, the lizhi is a state in which the final payout is indefinite even if a payout has been determined before the establishment of the final state. In this way, a benefit (e.g., normal payout) of the first amount is awarded in the lizhi, and a benefit of the second amount which is larger than the first amount is awarded in the final state.

In addition to the above, the lizhi may be arranged such that a normal payout is determined and then the progressive value is determined when jackpot is won in the final state. In other words, a benefit (e.g., normal payout) of the first type is awarded in the lizhi, and a benefit of the second type (e.g., progressive value when winning jackpot) is awarded in the final state.

Subsequently, the main CPU 222 determines a lizhi effect with reference to the lizhi effect table selected in the step S2321 (S2323), and ends the sub routine. The lizhi effect is an operation performed from the intermediate state in which at least of the five reels 101 to 105 stops whereas the remaining reels are rotating to the stop of all of the five reels 101 to 105.

The lizhi effect table sets weights for plural types of lizhi effects, respectively. The step S2323 is a process for generating a random number and selecting one of the plural types of the lizhi effects by using the generated random number and with reference to the lizhi effect table. With this, different lizhi effects are performed even if the stop pattern is the same, and hence various lizhi effects are executable.

The lizhi effect table is provided for each of the normal game mode and the free game mode. This makes it possible to perform a different lizhi effect in each game mode.

As described above, the lizhi effect from the intermediate state of the reels to the rotation stop is determined based on the number of JACKPOT to appear, which form the to-be-stopped symbol matrix, and the arrangement pattern. Being similar to the indication effect, the direction of the rotation, the speed of the rotation, the time of the rotation, and other aspects of the rotation of the five reels 101 to 105 are determined when the lizhi effect is determined.

For each lizhi effect, a motor control parameter for controlling a motor to drive the five reels 101 to 105 is set in advance and stored in the RAM 226. When the lizhi effect is determined, the corresponding motor control parameter is read and the motor is controlled, and hence the effect is executed by the five reels 101 to 105.

### Symbol Display Control Process

Now, the symbol display control process will be described with reference to FIG. 24. FIG. 24 is a flowchart of the symbol display control process in the gaming machine 10 of the embodiment of the present invention.

To begin with, the reel control processing unit 308 executed by the main CPU 222 rotates the first to fifth reels 101 to 105 in accordance with the indication effect determined in the step S2319 shown in FIG. 23 (S2411).

To be more specific, to begin with, the reel control processing unit 308 sends a rotation control signal to a reel assembly M11 in accordance with the indication effect determined in the step S2319 shown in FIG. 23. Then a reel driver 264 for the first to fifth reels 101 to 105 supplies power to a reel motor 272 so as to rotate the first to fifth reels 101 to 105. As a result of this rotation control, the first to fifth reels 101 to 105 rotate at a predetermined speed, and the symbol columns on the first to fifth reels 101 to 105 scroll in the display window 150 of the symbol display unit 40.

Subsequently, the reel control processing unit 308 executed by the main CPU 222 stops at least one of the first to fifth reels 101 to 105 in accordance with the indication effect determined in the step S2319 shown in FIG. 23 (S2413).

To be more specific, a spin control signal includes information of stop positions of the first to fifth reels 101 to 105 calculated from the indication effect. The reel driver 264 of the first to fifth reels 101 to 105 controls the reel motor 272 so as to stop the at least one of the first to fifth reels 101 to 105 in accordance with the indication effect, at the position indicated by the spin control signal.

As such, the at least one of the reels indicated by the indication effect stops at a desired position by the reel motor 272 formed of a stepper motor, and the scroll of the symbol column is stopped so that the to-be-stopped symbol is arranged in the central stage of the symbol matrix formed in the display window 150.

Subsequently, the reel control processing unit 308 executed by the main CPU 222 rotates the first to fifth reels 101 to 105 in accordance with the lizhi effect determined in the step S2323 shown in FIG. 23 (S2415).

To be more specific, to begin with, the reel control processing unit 308 sends a rotation control signal to the reel assembly M11 in accordance with the reel effect determined in the step S2323 shown in FIG. 23. Subsequently, the reel driver 264 of the first to fifth reels 101 to 105 supplies power to the reel motor 272 so as to rotate some of the first to fifth reels 101 to 105 which are rotating. With this rotation control, the reels which are rotating among the first to fifth reels 101 to 105 rotate at a predetermined speed, and the symbol columns of these reels scroll in the display window 150 of the symbol display unit 40.

Subsequently, the reel control processing unit 308 executed by the main CPU 222 stops the rotating ones of the first to fifth reels 101 to 105 in accordance with the lizhi effect determined in the step S2323 shown in FIG. 23 (S2417).

To be more specific, the spin control signal includes information of the stop positions of the first to fifth reels 101 to 105 calculated from the lizhi effect. The reel driver 264 of the first to fifth reels 101 to 105 controls the reel motor 272 so as to stop the rotating ones of the first to fifth reels 101 to 105 at the positions indicated by the spin control signal.

With this, all of the first to fifth reels 101 to 105 stop and 15 symbols are rearranged in the display window 150, with the result that the symbol matrix is formed.

### Payout Determination Process

Now, the payout determination process will be described with reference to FIG. 25. FIG. 25 is a flowchart of the payout determination process in the gaming machine 10 of the embodiment of the present invention.

To begin with, the main CPU 222 determines a payout amount with reference to the symbol storage area and the payout table (FIG. 15 and FIG. 16) and based on a payout satisfying a winning pattern (S2511).

For example, when four RED7 are successively displayed from the left along one of 30 paylines, a payout of 100 credits is determined.

The determined payout amount is stored in the payout counter 321 in the payout amount storage area (S2513).

Subsequently, the main CPU 222 determines whether a jackpot winning has been achieved (S2515).

When the jackpot winning has not been achieved, the main CPU 222 immediately ends the sub routine.

When the jackpot winning has been achieved, the main CPU 222 notifies the external controller 190 of the achievement of the jackpot winning (S2517). Upon receiving the notification, the external controller 190 sends, to the gaming machine 10, the progressive value which has been updated.

At this stage, a part of the progressive value (e.g., 80 percent) may be paid out, and the remainder (e.g., 20 percent) may be carried over for the next establishment of the jackpot trigger.

Subsequently, the main CPU 222 receives a progressive value from the external controller 190 (S2519). Subsequently, the main CPU 222 further stores the received progressive value in the payout amount storage area (S2521). After this step, the payout determination process is terminated.

As such, when the jackpot winning is achieved, the progressive value is paid out in addition to the awarding of the normal payout.

While in the example above the progressive value is stored in the external controller 190, the progressive value may be independently stored in each gaming machine 10 as a stand-alone jackpot.

### Free Game Mode Process

To begin with, the free game mode process will be described with reference to FIG. 26. FIG. 26 is a flowchart of the free game mode process in the gaming machine 10 of the embodiment of the present invention.

To begin with, the main CPU 222 executes an at-one-game-end initialization process (S2611). This process clears data in a working area of the RAM 226, which becomes unnecessary at the end of each round of game, e.g., symbols randomly determined, and the like.

The bet amount in the free game mode is identical with the bet amount in the normal game mode immediately before the shifting to the free game mode.

Subsequently, the main CPU 222 determines whether the spin button has been operated (S2613).

Subsequently, the main CPU 222 executes the symbol random determination process which described with reference to FIG. 22 (S2615). In this process, to-be-stopped symbols are determined based on symbol determination random numbers. In this step S2615, the to-be-stopped symbols are determined with reference to the symbol determination table which is shown in FIG. 15 and defines the weight in the free game mode.

Subsequently, the effect control processing unit 312 executed by the main CPU 222 executes an effect content determination execution process (S2617). This step is identical with the step S2015 shown in FIG. 20.

Subsequently, the main CPU 222 executes a symbol display control process shown in FIG. 24 (S2619). This step is identical with the step 52016 shown in FIG. 20.

Subsequently, the main CPU 222 executes the payout determination process described with reference to FIG. 25 (S2621). This step is identical with the step S2017 shown in FIG. 20.

Subsequently, the main CPU 222 executes a payout process (S2623). The main CPU 222 adds the value (payout counter 321) stored in the payout amount storage area to the value (credit amount counter 320) stored in the credit amount storage area provided in the RAM 226. Alternatively, the hopper 242 is controlled so that a coin corresponding to the payout counter 321 is discharged from the coin payout exit. Alternatively, the ticket printer 120 is controlled so that a ticket with a barcode, in which the payout counter 321 is recorded, is issued.

Subsequently, the main CPU 222 determines whether the re-trigger has been established (S2625). In the present embodiment, the re-trigger is established when the BONUS symbol on the reel M3c appears in the display window 150.

When the re-trigger has been established, the main CPU 222 returns to the step S2611. In the meanwhile, the main CPU 222 ends the sub routine when the re-trigger has not been established.

In this way, when the re-trigger is established, the free game mode is maintained and single execution of the unit game is added in the free game mode. When the re-trigger is not established, after the execution of the mystery random determination process (S2626), the free game mode is shifted to the normal game mode.

### Kind Number Determination Process

Now, the Kind number determination process will be described with reference to FIG. 27. FIG. 27 is a flowchart of the Kind number determination process in the gaming machine 10 of the embodiment of the present invention. This is a process for determining the number of JACKPOT in the to-be-stopped symbol matrix which is formed of the to-be-stopped symbols rearranged when all of the five reels 101 to 105 stop.

To begin with, the main CPU 222 determines whether the number of JACKPOT is 10 Kind (S2711). Because JACKPOT is a scatter symbol as described above, the determination in the step S2711 is a process of determining whether 10 JACKPOT appears in the display window 150.

When the number of JACKPOT is 10 Kind, the main CPU 222 sets the first identifier at I (S2713) and ends the sub routine.

When the number of JACKPOT is not 10 Kind, the main CPU 222 determines whether the number of JACKPOT is 9 Kind (S2715). In other words, whether nine JACKPOT symbols appear in the display window 150 is determined.

When the number of JACKPOT is 9 Kind, the main CPU 222 sets the first identifier at II (S2717) and ends the sub routine.

When the number of JACKPOT is not 9 Kind, the main CPU 222 determine whether the number of JACKPOT is 8 Kind (S2719). In other words, whether eight JACKPOT symbols appear in the display window 150 is determined.

When the number of JACKPOT is 8 Kind, the main CPU 222 sets the first identifier at III (S2721) and ends the sub routine.

When the number of JACKPOT is not 8 Kind, the main CPU 222 determines whether the number of JACKPOT is 7 Kind (S2723). In other words, whether seven JACKPOT symbols appear in the display window 150 is determined.

When the number of JACKPOT is 7 Kind, the main CPU 222 sets the first identifier at IV (S2725) and ends the sub routine.

When the number of JACKPOT is not 7 Kind, the main CPU 222 determines whether the number of JACKPOT is 6 Kind (S2727). In other words, whether six JACKPOT symbols appear in the display window 150 is determined.

When the number of JACKPOT is 6 Kind, the main CPU 222 sets the first identifier at V (S2729) and ends the sub routine.

When the number of JACKPOT is not 6 Kind, the main CPU 222 determines whether the number of JACKPOT is 5 Kind (S2731). In other words, whether five JACKPOT symbols appear in the display window 150 is determined.

When the number of JACKPOT is 5 Kind, the main CPU 222 sets the first identifier at VI (S2733) and ends the sub routine.

When the number of JACKPOT is not 5 Kind, the main CPU 222 determines whether the number of JACKPOT is 4 Kind (S2735). In other words, whether four JACKPOT symbols appear in the display window 150 is determined.

When the number of JACKPOT is 4 Kind, the main CPU 222 sets the first identifier at VII (S2737) and ends the sub routine.

When the number of JACKPOT is not 4 Kind, the main CPU 222 sets the first identifier at VIII (S2739) and ends the sub routine.

### Mystery Random Determination Process

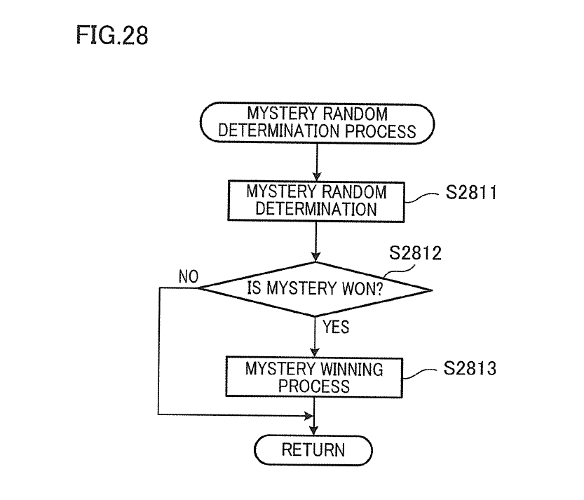

Referring to FIG. 28, the free game mode process will be described. FIG. 28 is a flowchart of the mystery random determination process in the gaming machine 10 of the embodiment of the present invention.

To begin with, the main CPU 222 executes the mystery random determination with reference to the mystery random determination table shown in FIG. 17 (S2811). When mystery winning is not achieved (S2812: NO), the routine is terminated. In the meanwhile, when mystery winning is achieved (S2812: YES), the mystery winning process is executed with reference to the jackpot symbol rearrangement state tables shown in FIG. 18A to FIG. 18E (S2813), and then the routine is terminated.

The mystery winning process is specifically described as follows. As shown in FIG. 17, when, for example, a mystery winning with the progressive rank 1st is achieved, the rearrangement state table shown in FIG. 18A is referred to because the number of the rearranged jackpot symbols is 10 Kind. Then one of the rearrangement states 0 to 2 is selected by the random determination based on the weight, and the jackpot symbols are rearranged with reference to the selected one of the rearrangement states 0 to 2. When a mystery winning with the progressive rank 2nd is achieved, the rearrangement state table shown in FIG. 18B is referred to because the number of the rearranged jackpot symbols is 9 Kind. Then one of the rearrangement states 0 to 2 is selected by the random determination based on the weight, and the jackpot symbols are rearranged with reference to the selected one of the rearrangement states 0 to 2.

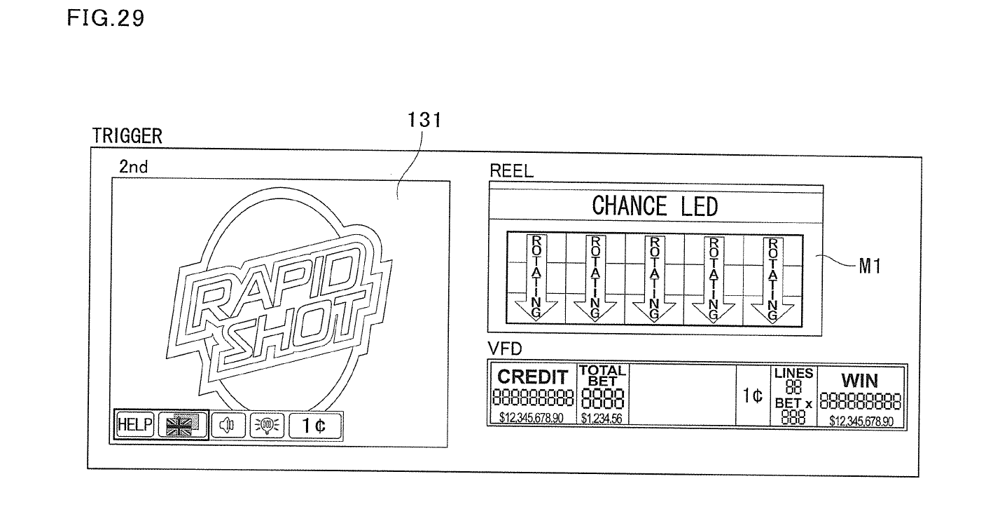

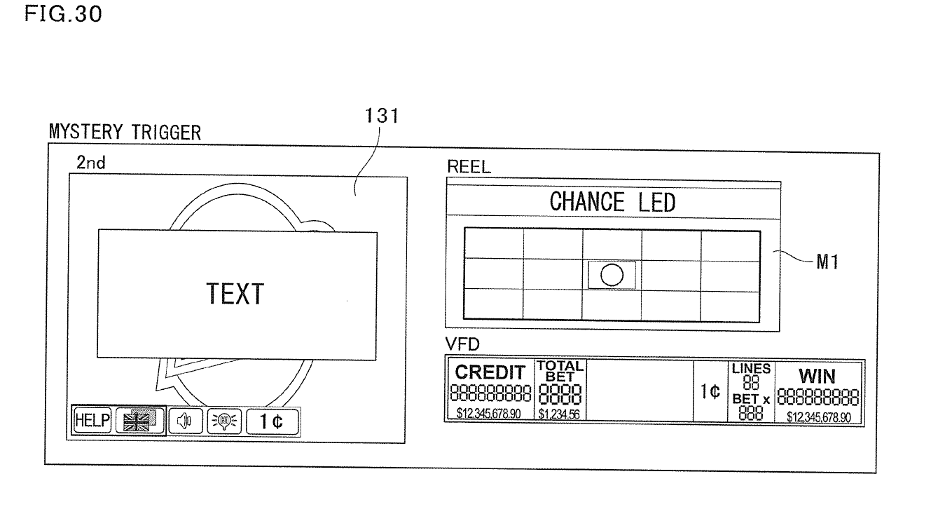

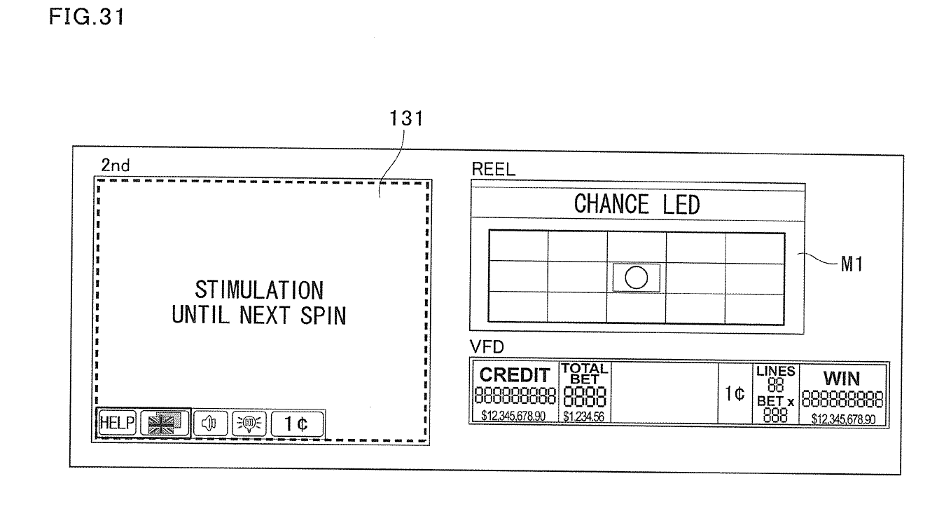

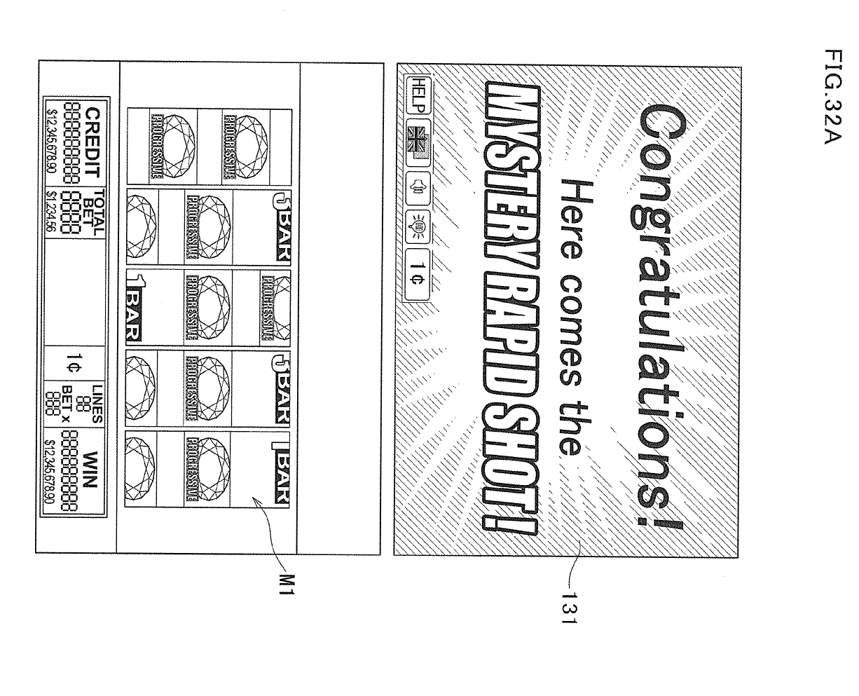

In the mystery winning process, an effect of notifying the mystery winning is performed on the upper image display panel 131 shown in FIG. 9. That is to say, after the free game mode process (chance game) ends as shown in FIG. 29, a text notifying the achievement of the mystery winning is displayed as shown in FIG. 30, and the achievement of the mystery winning is notified by sound. Then the effect process similar to that in the chance game is executed as shown in FIG. 31.

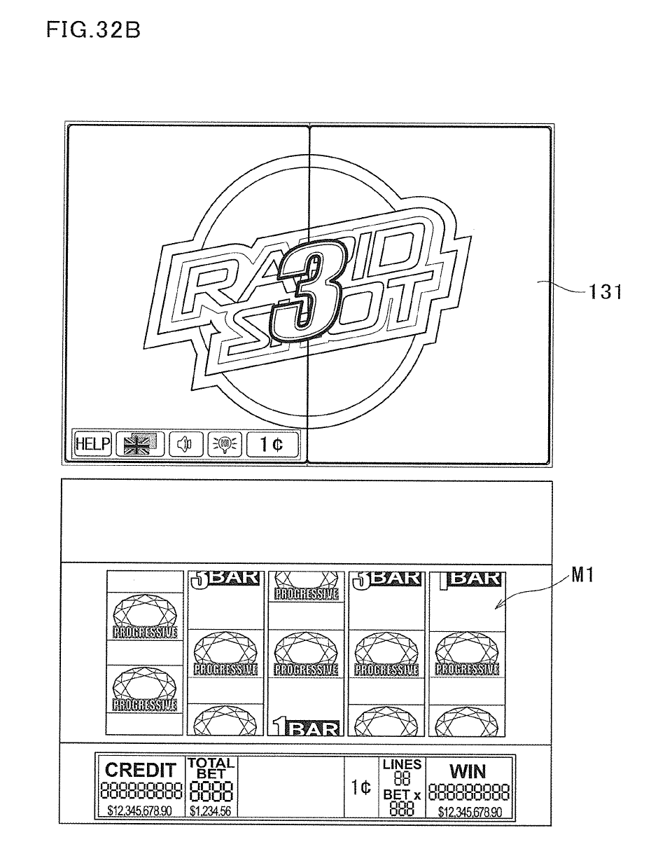

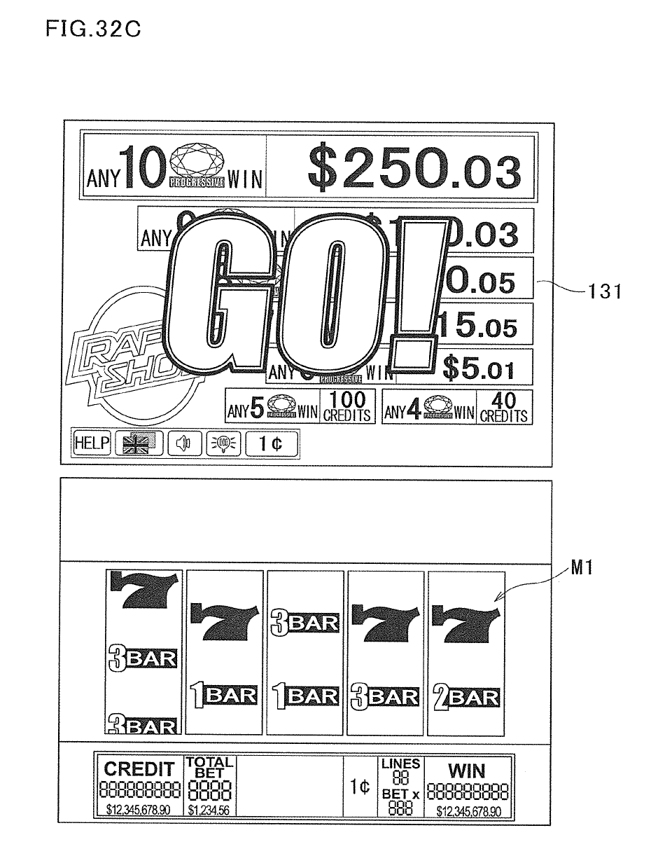

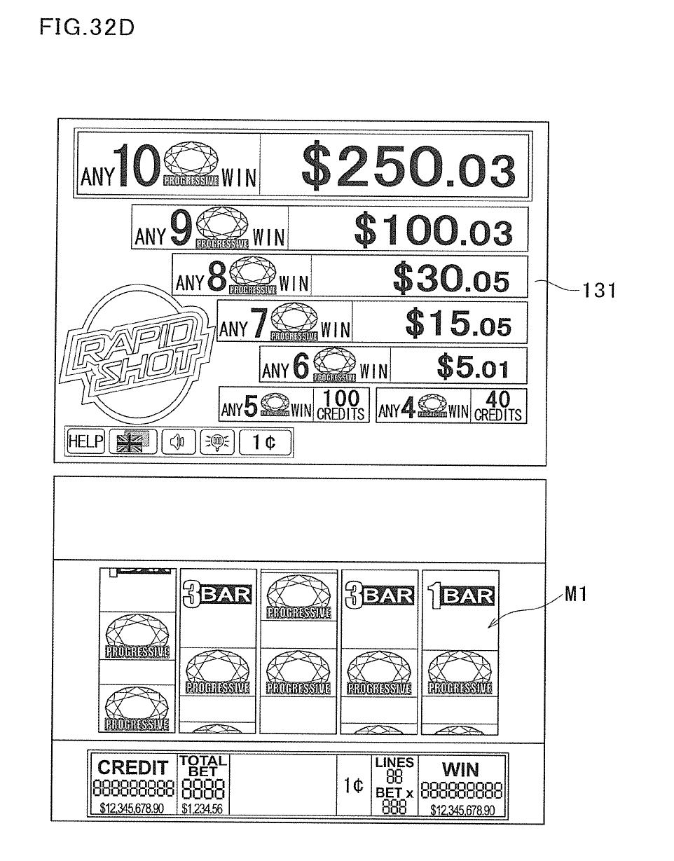

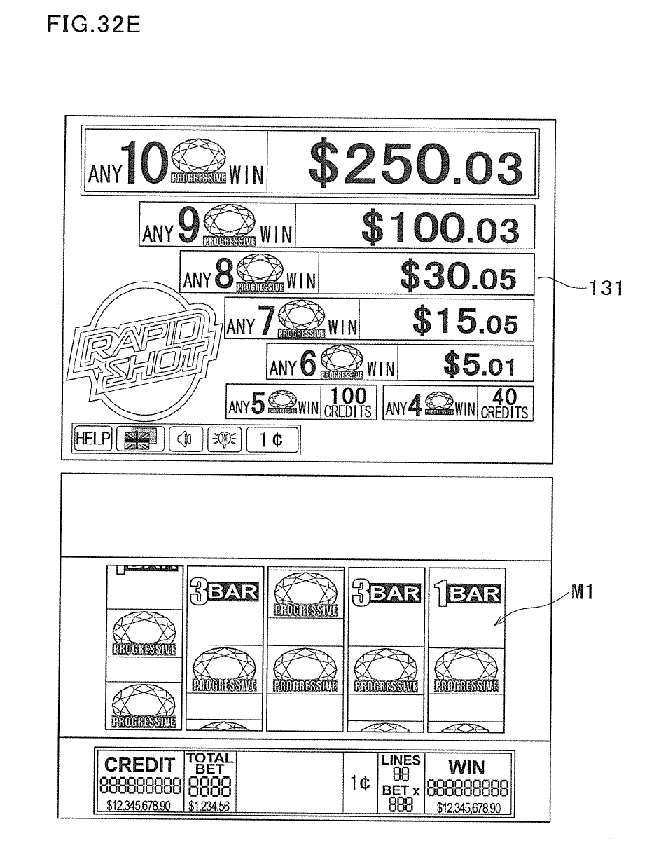

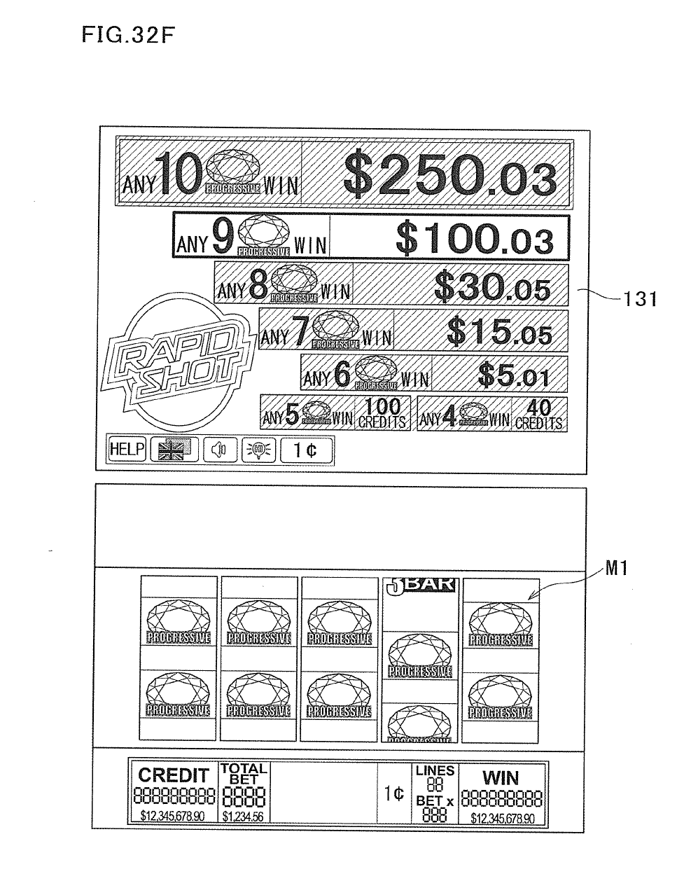

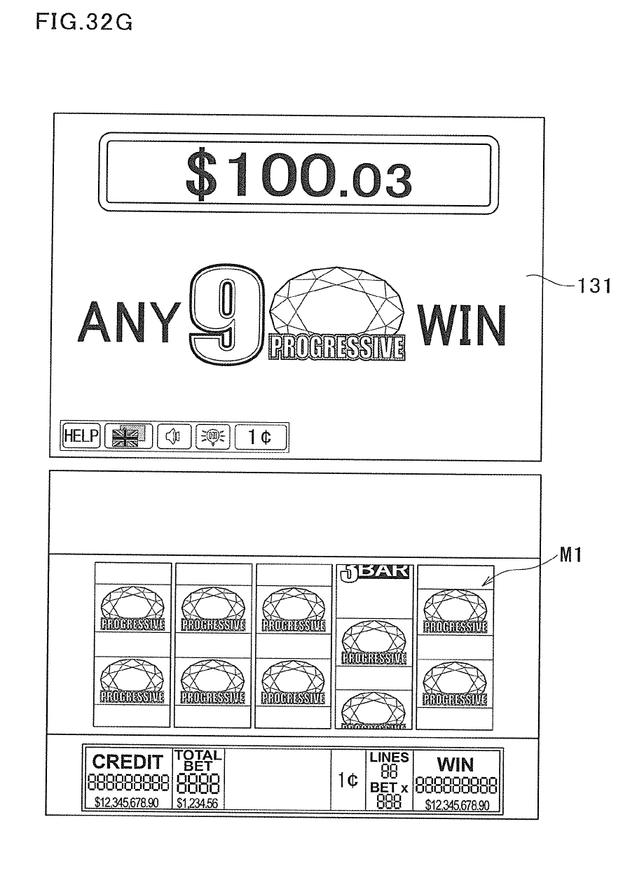

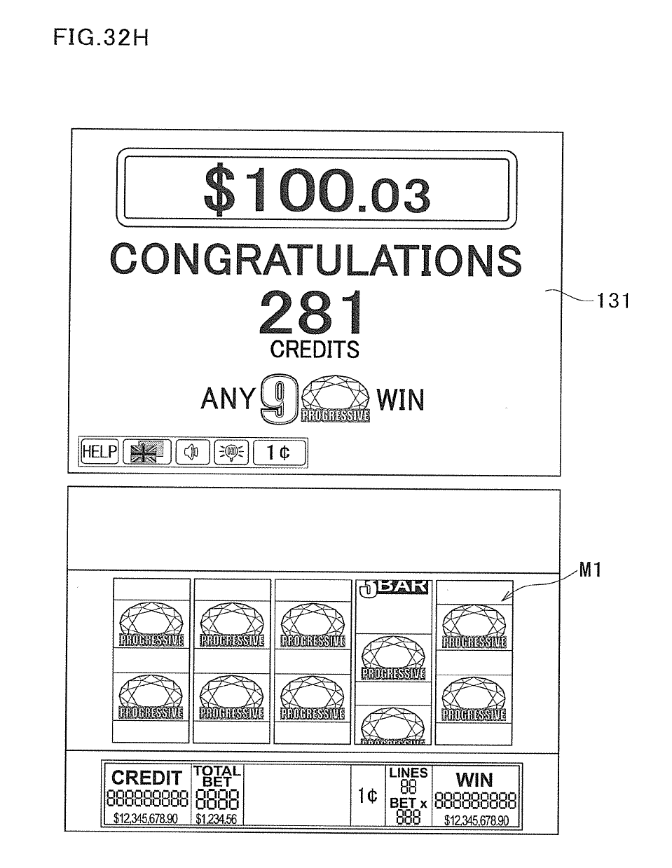

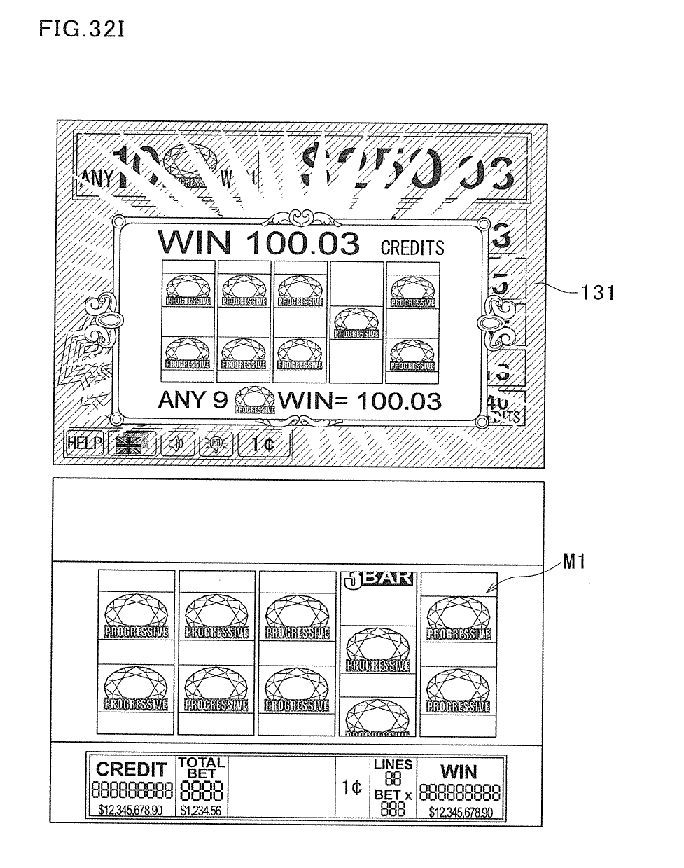

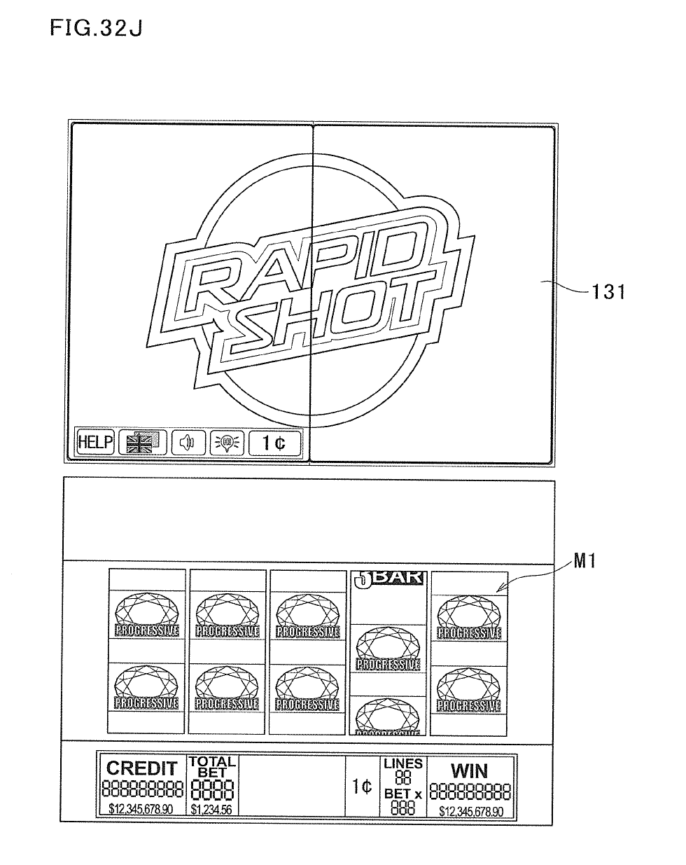

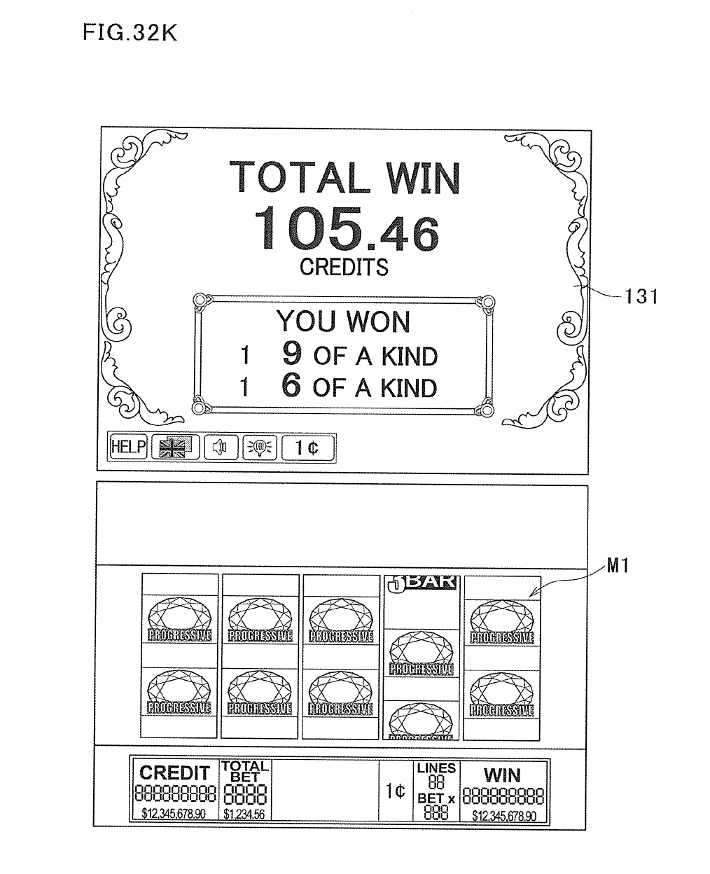

The effect in the mystery winning process is specifically described as follows. As shown in FIG. 32A, the winning in the mystery random determination is notified on the upper image display panel 131. As shown in FIG. 32B, a three-second countdown starts and “GO” is displayed as shown in FIG. 32C when the countdown ends, and the rotation of the reels 101, 102, 103, 104, and 105 starts.

As shown in FIG. 32D to FIG. 32E, the reels 101, 102, 103, 104, and 105 keep the rotation while the effect is executed therefor by illumination and colors different from those in the normal game and the chance game. Then the symbols are rearranged as shown in FIG. 32F. As a result, as shown in FIG. 32G, when the number of the rearranged jackpot symbols is nine, the number of rearranged jackpots and the obtained amount are displayed on the upper image display panel 131 and then the obtained credit amount is displayed as shown in FIG. 32H.

Thereafter, a win signboard is displayed as shown in FIG. 32I, and the rearrangement state of the jackpot and the obtained credit amount are displayed. The door is closed as shown in FIG. 32J, and then a total win signboard is displayed as shown in FIG. 32K, in which the credits are counted up while a lot of coins or the like fall in the background screen.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process executed in or by respective steps yielding one result or blocks with a predetermined processing function described in the present specification shall be understood as a process with no self-contradiction. Further, the electrical or magnetic signal is transmitted/received and written in the respective steps. It should be noted that such a signal is expressed in the form of bit, value, symbol, text, terms, number, or the like solely for the sake of convenience. Although the present specification occasionally personifies the processes carried out in the steps, these processes are essentially executed by various devices. Further, the other structures necessary for the steps are obvious from the above descriptions.

### Other Features in Embodiment

The embodiment above encompasses another feature as below. That is to say, a gaming system formed of gaming machines includes: the gaming machines each of which includes a symbol display device on which a result of a game is displayed by variably displaying symbols and then rearranging the symbols;

a connection unit connected with each of the gaming machines;

a storage unit configured to store a special payout which is a common payout obtainable by the gaming machines; and

a control unit which is configured to display the symbols in a display state for awarding the special payout (identical display state in which N jackpot symbols are rearranged) when the game result in the gaming machines is awarding of the special payout, and to award the special payout,

a first control unit in a first gaming machine of the gaming machines being configured to rearrange the symbols at stop positions determined by symbol random determination and execute random determination of whether to award the special payout at a first probability based on the game result of the rearrangement; and

when the game result of the rearrangement is a trigger for a change in a game mode (i.e., the trigger is rearrangement of the bonus symbol on the third reel 103), change the game mode and execute second random determination (which is different from the symbol random determination), and execute random determination of whether a result of the second random determination is the game result of awarding the special payout, at a second probability,

a second control unit of a second gaming machine in the gaming machines being configured to rearrange the symbols at stop positions determined in symbol random determination, and randomly determine whether to award the special payout at a third probability based on the game result of the rearrangement; and

when the game result of the rearrangement is a trigger for a change in a game mode (i.e., the trigger is rearrangement of the bonus symbol on the third reel 103), change the game mode and execute second random determination (which is different from the symbol random determination), and execute random determination of whether a result of the second random determination is the game result of awarding the special payout, at a fourth probability,

a synthetic probability of the first and second probabilities executed by the first control unit being arranged to be identical with a synthetic probability of the third and fourth probabilities executed by the second control unit.

In addition to the above, the embodiment above encompasses a further feature as below. That is to say, a gaming system formed of gaming machines includes: the gaming machines each of which includes a symbol display device on which a result of a game is displayed by variably displaying symbols and then rearranging the symbols;

a connection unit connected with each of the gaming machines;

a storage unit configured to store a special payout which is a common payout obtainable by the gaming machines; and

a control unit which is configured to display the symbols in a display state for awarding the special payout (identical display state in which N jackpot symbols are rearranged) when the game result in the gaming machines is awarding of the special payout, and to award the special payout,

a control unit of a gaming machine in the gaming machines being configured to rearrange the symbols at stop positions determined by symbol random determination and randomly determine whether to award the special payout at a first symbol random determination probability based on the game result of the rearrangement;

when the game result of the rearrangement is a trigger for a change in a game mode (i.e., the trigger is rearrangement of the bonus symbol on the third reel 103), change the game mode and execute second random determination (which is different from the symbol random determination), and execute random determination of whether a result of the second random determination is the game result of awarding the special payout, at a predetermined probability,

another control unit of another gaming machine which is different from the gaming machine above in the gaming machines being configured to arrange the symbols at stop positions determined in symbol random determination, and randomly determine whether to award the special payout at a second symbol random determination probability based on the game result of the rearrangement,

a synthetic probability of the first symbol random determination probability and the predetermined probability executed by the control unit being arranged to be identical with the second symbol random determination probability executed by the another control unit.

What is claimed is:

1. A gaming system comprising a server which includes:
a connection unit connected with gaming machines; and
a storage unit configured to store a special payout which is a common payout obtainable by the gaming machines,
each of the gaming machines including:
a symbol display device configured to display a game result by variably displaying symbols and then rearranging the symbols; and
a control unit which is programmed to execute the processes of:
(A) determining the symbols to be rearranged on the symbol display device by symbol random determination in which random determination probabilities of the symbols are different between the gaming machines;
(B) based on the symbols rearranged by the symbol random determination, awarding the special payout; and
(C) awarding the special payout by second random determination in which random determination is executed at a predetermined probability, which is different from the symbol random determination in the process (A).

2. The gaming system according to claim 1, wherein,
each of the gaming machines includes an input device configured to receive a bet operation to output a bet amount for executing a game,
the server includes a calculation unit configured to receive the bet amount from the gaming machines and calculate the special payout based on the bet amount, and
the gaming system further includes a display device configured to display the special payout calculated by the calculation unit.

3. The gaming system according to claim 1, wherein,
the control unit is programmed to further execute the process of
rearranging the symbols on the symbol display device in a display state corresponding to the special payout determined in the process (C).

4. The gaming system according to claim 1, wherein,
the connection unit is further connected with a gaming machine which includes another control unit which is configured to determine the special payout by the symbol random determination and award the special payout.

5. The gaming system according to claim 1, further comprising
a storage unit which is configured to collect a part of each bet on the gaming machines connected to the connection unit at an identical rate, and accumulatively store the part as accumulative storage data,
the processing unit awarding the special payout based on the accumulative storage data in the storage unit.

6. The gaming system according to claim 1, wherein,
the control unit is programmed to further execute the process of
(D) in accordance with a result of the symbol random determination, executing a high-probability game in which the special payout is won at a high probability, and then executing the second random determination.

7. The gaming system according to claim 2, wherein,
the control unit is programmed to further execute the process of
rearranging the symbols on the symbol display device in a display state corresponding to the special payout determined in the process (C).

8. The gaming system according to claim 7, wherein,
the connection unit is further connected with a gaming machine which includes another control unit which is configured to determine the special payout by the symbol random determination and award the special payout.

9. The gaming system according to claim 8, further comprising
a storage unit which is configured to collect a part of each bet on the gaming machines connected to the connection unit at an identical rate and accumulatively store the part as accumulative storage data, the processing unit awarding the special payout based on the accumulative storage data in the storage unit.

10. The gaming system according to claim 9, wherein,
the control unit is programmed to further execute the process of
(D) in accordance with a result of the symbol random determination, executing a high-probability game in which the special payout is won at a high probability, and then executing the second random determination.
